(19) United States
(12) Patent Application Publication
(10) Pub. No.: US 2025/0318002 A1
(43) Pub. Date: Oct. 9, 2025

(54) TECHNIQUES FOR ENABLING TOKEN-BASED CONNECTIONS FOR ACCESS TRAFFIC STEERING, SWITCHING, AND SPLITTING ARCHITECTURE

(71) Applicant: QUALCOMM Incorporated, San Diego, CA (US)

(72) Inventors: Dario Serafino TONESI, San Diego, CA (US); Soo Bum LEE, San Diego, CA (US); Stefano FACCIN, San Ysidro, CA (US); Adrian Edward ESCOTT, Reading (GB)

(21) Appl. No.: 18/987,165

(22) Filed: Dec. 19, 2024

Related U.S. Application Data
(60) Provisional application No. 63/574,585, filed on Apr. 4, 2024.

(51) Int. Cl. H04W 76/15; H04W 12/06

(52) U.S. Cl. CPC H04W 76/15; H04W 12/06

(57) ABSTRACT

Various aspects of the present disclosure generally relate to wireless communication. In some aspects, a user equipment (UE) may transmit, over a Third Generation Partnership Project (3GPP) access to a network, a request to establish a protocol data unit (PDU) session that includes a first connection via the 3GPP access and a second connection via a non-3GPP access. The UE may receive a set of connection parameters for connecting to the network entity via the PDU session, including at least one of a connection identifier, a token, or an internet protocol address of the network entity. The UE may establish the first connection via the 3GPP access. The UE may establish the second connection via the non-3GPP access by transmitting a connection request, via the non-3GPP access, that includes at least one of the token or the connection identifier. Numerous other aspects are described.

### CROSS-REFERENCE TO RELATED APPLICATION

This patent application claims priority to U.S. Provisional Patent Application No. 63/574,585, filed on Apr. 4, 2024, entitled “TECHNIQUES FOR ENABLING TOKEN-BASED CONNECTIONS FOR ACCESS TRAFFIC STEERING, SWITCHING, AND SPLITTING ARCHITECTURE,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods for enabling token-based connections for access traffic steering, switching, and splitting architecture.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a user equipment (UE) for wireless communication. The user equipment may include one or more memories and one or more processors coupled to the one or more memories. The one or more processors may be individually or collectively configured to transmit, over a Third Generation Partnership Project (3GPP) access to a network, a request to establish a protocol data unit (PDU) session for communications between the UE and a network entity, wherein the request to establish the PDU session includes an indication for establishment of connectivity with the network entity via a non-3GPP access to the network, and wherein the PDU session includes a first connection via the 3GPP access and a second connection via the non-3GPP access. The one or more processors may be individually or collectively configured to receive, from the network, a set of connection parameters for connecting to the network entity via the PDU session, wherein the set of connection parameters includes at least one of a connection identifier, a token, or an internet protocol (IP) address of the network entity. The one or more processors may be individually or collectively configured to establish the first connection with the network entity via the 3GPP access. The one or more processors may be individually or collectively configured to establish the second connection with the network entity via the non-3GPP access by transmitting a connection request, via the non-3GPP access, that includes at least one of the token or the connection identifier.

Some aspects described herein relate to a user plane function (UPF) entity for wireless communication. The UPF entity may include one or more memories and one or more processors coupled to the one or more memories. The one or more processors may be individually or collectively configured to establish, with a UE, a first connection of a PDU session for communications between the UE and the UPF entity, wherein the PDU session includes the first connection via a 3GPP access to a network and a second connection via a non-3GPP access to the network. The one or more processors may be individually or collectively configured to establish, with the UE, the second connection of the PDU session, wherein the one or more processors, to establish the second connection, may be individually or collectively configured to receive, via the non-3GPP access, a connection request that includes at least one of a token or a connection identifier, and validate the UE as a trusted user of the non-3GPP access based at least in part on the at least one of the token or the connection identifier.

Some aspects described herein relate to a session management function (SMF) entity for wireless communication. The SMF entity may include one or more memories and one or more processors coupled to the one or more memories. The one or more processors may be individually or collectively configured to receive, from a UE over a 3GPP access to a network, a request to establish a PDU session for communications between the UE and a network entity, wherein the request to establish the PDU session includes an indication for establishment of connectivity with the network entity via a non-3GPP access to the network, and wherein the PDU session includes a first connection via the 3GPP access and a second connection via the non-3GPP access. The one or more processors may be individually or collectively configured to transmit, to the UE, a set of connection parameters for connecting to the network entity via the PDU session, where the connection parameters include an IP address of the network entity, and wherein at least one of: the request to establish the PDU session includes a token that is used to establish the second connection via the non-3GPP access, or the set of connection parameters includes at least one of the token or a connection identifier that is used to establish the second connection via the non-3GPP access.

Some aspects described herein relate to a method of wireless communication performed by a UE. The method may include transmitting, over a 3GPP access to a network, a request to establish a PDU session for communications between the UE and a network entity, wherein the request to establish the PDU session includes an indication for establishment of connectivity with the network entity via a non-3GPP access to the network, and wherein the PDU session includes a first connection via the 3GPP access and a second connection via the non-3GPP access. The method may include receiving, from the network, a set of connection parameters for connecting to the network entity via the PDU session, wherein the set of connection parameters includes at least one of a connection identifier, a token, or an IP address of the network entity. The method may include establishing the first connection with the network entity via the 3GPP access. The method may include establishing the second connection with the network entity via the non-3GPP access, wherein establishing the second connection includes transmitting a connection request, via the non-3GPP access, that includes at least one of the token or the connection identifier.

Some aspects described herein relate to a method of wireless communication performed by a UPF entity of a network. The method may include establishing, with a UE, a first connection of a PDU session for communications between the UE and the UPF entity, wherein the PDU session includes the first connection via a 3GPP access to the network and a second connection via a non-3GPP access to the network. The method may include establishing, with the UE, the second connection of the PDU session, where establishing the second connection includes: receiving, via the non-3GPP access, a connection request that includes at least one of a token or a connection identifier, and validating the UE as a trusted user of the non-3GPP access based at least in part on the at least one of the token or the connection identifier.

Some aspects described herein relate to a method of wireless communication performed by an SMF entity of a network. The method may include receiving, from a UE over a 3GPP access to the network, a request to establish a PDU session for communications between the UE and a network entity, wherein the request to establish the PDU session includes an indication for establishment of connectivity with the network entity via a non-3GPP access to the network, and wherein the PDU session includes a first connection via a the 3GPP access and a second connection via the non-3GPP access. The method may include transmitting, to the UE, a set of connection parameters for connecting to the network entity via the PDU session, wherein the connection parameters include an IP address of the network entity, and wherein at least one of: the request to establish the PDU session includes a token that is used to establish the second connection via the non-3GPP access, or the set of connection parameters includes at least one of the token or a connection identifier that is used to establish the second connection via the non-3GPP access.

Some aspects described herein relate to a non-transitory computer-readable medium that stores a set of instructions for wireless communication by a UE. The set of instructions, when executed by one or more processors of the UE, may cause the UE to transmit, over a 3GPP access to a network, a request to establish a PDU session for communications between the UE and a network entity, where the request to establish the PDU session includes an indication for establishment of connectivity with the network entity via a non-3GPP access to the network, and wherein the PDU session includes a first connection via the 3GPP access and a second connection via the non-3GPP access. The set of instructions, when executed by one or more processors of the UE, may cause the UE to receive, from the network, a set of connection parameters for connecting to the network entity via the PDU session, wherein the set of connection parameters includes at least one of a connection identifier, a token, or an IP address of the network entity. The set of instructions, when executed by one or more processors of the UE, may cause the UE to establish the first connection with the network entity via the 3GPP access. The set of instructions, when executed by one or more processors of the UE, may cause the UE to establish the second connection with the network entity via the non-3GPP access, wherein the set of instructions, that cause the UE to establish the second connection, cause the UE to transmit a connection request, via the non-3GPP access, that includes at least one of the token or the connection identifier.

Some aspects described herein relate to a non-transitory computer-readable medium that stores a set of instructions for wireless communication by a UPF entity. The set of instructions, when executed by one or more processors of the UPF entity, may cause the UPF entity to establish, with a UE, a first connection of a PDU session for communications between the UE and the UPF entity, where the PDU session includes the first connection via a 3GPP access to a network and a second connection via a non-3GPP access to the network. The set of instructions, when executed by one or more processors of the UPF entity, may cause the UPF entity to establish, with the UE, the second connection of the PDU session, wherein the one or more instructions, that cause the UPF entity to establish the second connection, cause the UPF entity to: receive, via the non-3GPP access, a connection request that includes at least one of a token or a connection identifier, and validate the UE as a trusted user of the non-3GPP access based at least in part on the at least one of the token or the connection identifier.

Some aspects described herein relate to a non-transitory computer-readable medium that stores a set of instructions for wireless communication by an SMF entity. The set of instructions, when executed by one or more processors of the SMF entity, may cause the SMF entity to receive, from a UE over a 3GPP access to a network, a request to establish a PDU session for communications between the UE and a network entity, wherein the request to establish the PDU session includes an indication for establishment of connectivity with the network entity via a non-3GPP access to the network, and wherein the PDU session includes a first connection via the 3GPP access and a second connection via the non-3GPP access. The set of instructions, when executed by one or more processors of the SMF entity, may cause the SMF entity to transmit, to the UE, a set of connection parameters for connecting to the network entity via the PDU session, wherein the set of connection parameters includes an IP address of the network entity, and wherein at least one of: the request to establish the PDU session includes a token that is used to establish the second connection via the non-3GPP access, or the set of connection parameters includes at least one of the token or a connection identifier that is used to establish the second connection via the non-3GPP access.

Some aspects described herein relate to an apparatus for wireless communication. The apparatus may include means for transmitting, over a 3GPP access to a network, a request to establish a PDU session for communications between the apparatus and a network entity, wherein the request to establish the PDU session includes an indication for establishment of connectivity with the network entity via a non-3GPP access to the network, and wherein the PDU session includes a first connection via the 3GPP access and a second connection via the non-3GPP access. The apparatus may include means for receiving, from the network, a set of connection parameters for connecting to the network entity via the PDU session, wherein the set of connection parameters includes at least one of a connection identifier, a token, or an IP address of the network entity. The apparatus may include means for establishing the first connection with the network entity via the 3GPP access. The apparatus may include means for establishing the second connection with the network entity via the non-3GPP access, wherein the means for establishing the second connection includes means for transmitting a connection request, via the non-3GPP access, that includes at least one of the token or the connection identifier.

Some aspects described herein relate to an apparatus for wireless communication. The apparatus may include means for establishing, with a UE, a first connection of a PDU session for communications between the UE and the apparatus, wherein the PDU session includes the first connection via a 3GPP access to a network and a second connection via a non-3GPP access to the network. The apparatus may include means for establishing, with the UE, the second connection of the PDU session, wherein the means for establishing the second connection includes: means for receiving, via the non-3GPP access, a connection request that includes at least one of a token or a connection identifier, and means for validating the UE as a trusted user of the non-3GPP access based at least in part on the at least one of the token or the connection identifier.

Some aspects described herein relate to an apparatus for wireless communication. The apparatus may include means for receiving, from a UE over a 3GPP access to a network, a request to establish a PDU session for communications between the UE and a network entity, wherein the request to establish the PDU session includes an indication for establishment of connectivity with the network entity via a non-3GPP access to the network, and wherein the PDU session includes a first connection via the 3GPP access and a second connection via the non-3GPP access. The apparatus may include means for transmitting, to the UE, a set of connection parameters for connecting to the network entity via the PDU session, where the set of connection parameters includes an IP address of the network entity, and wherein at least one of: the request to establish the PDU session includes a token that is used to establish the second connection via the non-3GPP access, or the set of connection parameters includes at least one of the token or a connection identifier that is used to establish the second connection via the non-3GPP access.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network.

FIG. 3 is a diagram illustrating an example disaggregated base station architecture in accordance with the present disclosure.

FIG. 4 is a diagram of an example of a core network, in accordance with the present disclosure.

FIG. 5 is a diagram illustrating an example of an access traffic steering, switching, and splitting (ATSSS) architecture, in accordance with the present disclosure.

FIG. 6 is a diagram illustrating an example of a multi-access protocol data unit session in an ATSSS architecture, in accordance with the present disclosure.

FIG. 7 is a diagram illustrating an example associated with an ATSSS-Lite architecture, in accordance with the present disclosure.

FIG. 8 is a diagram illustrating an example associated with enabling token-based connections for an ATSSS architecture, in accordance with the present disclosure.

FIGS. 9A-9C is a diagram of another example associated with enabling token-based connections for an ATSSS architecture, in accordance with the present disclosure.

FIG. 10 is a diagram illustrating an example process performed, for example, at a UE or an apparatus of a UE, in accordance with the present disclosure.

FIG. 11 is a diagram illustrating an example process performed, for example, at a user plane function (UPF) entity or an apparatus of an UPF entity, in accordance with the present disclosure.

FIG. 12 is a diagram illustrating an example process performed, for example, at a session management function (SMF) entity or an apparatus of an SMF entity, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, a user equipment (UE) may be capable of communicating with a network entity via an access traffic steering, switching, and splitting (ATSSS) architecture. An ATSSS architecture may integrate a Third Generation Partnership Project (3GPP) access (e.g., a 5G NR cellular access) with a non-3GPP access (e.g., a Wi-Fi and/or wireline access) to allow traffic steering across multiple accesses at a finer granularity than a protocol data unit (PDU) session. In some examples, an ATSSS architecture may include an integrated non-3GPP access. An integrated non-3GPP access may include an integrated core network device to manage a non-3GPP access to the core network, such as a non-3GPP interworking function (N3IWF) entity. In such examples, the ATSSS architecture may include an NWu interface between the UE and the N3IWF for establishing secure tunnels between the UE and the N3IWF so that control-plane and user-plane traffic between the UE and the 5G core network is transferred securely over untrusted non-3GPP access.

In some other examples, an ATSSS architecture may include a non-integrated, non-3GPP access (NIN3A), which is sometimes referred to herein as an ATSSS-Lite architecture. In such examples, the ATSSS-Lite architecture may support traffic aggregation, steering, and switching for a PDU session across a 3GPP access and a non-integrated Internet protocol (IP) network (e.g., a generic IP access, such as Wi-Fi or another IP access available to the UE). In some examples, an NIN3A may be associated with an Nx interface that connects the UE to a network entity, such as a user plane function (UPF) entity of a 3GPP core network. In that regard, in ATSSS-Lite, the N3IWF entity (or else a similar entity, such as a trusted non-3GPP gateway function (TNGF) entity) is removed and is not replaced with any new network function. Instead, traffic transmitted via the Nx interface (e.g., the NIN3A) may be transmitted to the UPF via the Internet.

In some examples, filtering mechanisms associated with an N6 interface (e.g., an interface connecting the UPF to the data network) may allow incoming (e.g., downlink) traffic based on the UE-generated outgoing (e.g., uplink) traffic. For example, based on a UE transmitting uplink traffic, the UPF may store an IP address associated with the UE as a known (e.g., trusted) address. Accordingly, when responsive traffic is received from the data network over the N6 interface, the UPF may match the incoming traffic against the known IP address associated with the UE. In that regard, a UE may be required to transmit uplink traffic prior to the access stratum (AS) transmitting downlink traffic. Such filtering mechanisms may not work for certain multi-access scenarios, such as the ATSSS-Lite architecture described above, because incoming traffic at the UPF over the Nx interface (e.g., the NIN3A) is uplink traffic from the UE, and thus the UPF cannot match the traffic against any known IP addresses. On the other hand, if the UPF were to accept incoming traffic over the Nx interface from any entity, the UPF may be vulnerable to attacks. Accordingly, a network may forgo use of certain multi-access architectures (such as the ATSSS-Lite architecture) in order to ensure secure communications (e.g., the network may employ ATSSS architectures which employ an N3IWF and/or a TNGF in order to establish an IP security (IPSec) tunnel, among other examples), which may result in more complex ATSSS deployments and thus high power, computing, and network resource consumption, as well as high overhead associated with establishing and/or maintaining an IPSec tunnel.

Various aspects relate generally to enabling secure transmissions over an ATSSS architecture, such as an ATSSS-Lite architecture. As used herein, “ATSSS architecture” generally refers to both full-features ATSSS architectures and ATSSS-Lite architectures, among other ATSSS architectures. Some aspects more specifically relate to token-based connections for an ATSSS architecture. In some aspects, a UE may request establishment of a PDU session to a network, with the PDU session including a first connection via a 3GPP access and a second connection via a non-3GPP access (e.g., the UE may request establishment of a PDU session using an ATSSS architecture, such as an ATSSS-Lite architecture). In response, the UE may receive, from the network (e.g., a session management function (SMF) entity of the network), a set of connection parameters for connecting to a network entity via the PDU session, such as a connection identifier, a token, and/or IP address of the network entity. In aspects involving the token, the token may be generated by a core network entity (e.g., the SMF entity or a UPF entity) or else may be generated by the UE and provided to the network (e.g., the SMF entity) when the UE requests establishment of the PDU session. The UE may establish the PDU session with the network entity (e.g., with the UPF entity of the network), such as by establishing the first connection with the network entity via the 3GPP access and by establishing the second connection with the network entity via the non-3GPP access. In some aspects, the UE may establish the second connection by transmitting a connection request, via the non-3GPP access, that includes at least one of the token or the connection identifier, and the network entity (e.g., the UPF entity) may validate the UE as a trusted user of the non-3GPP access based at least in part on the token and/or the connection identifier.

Particular aspects of the subject matter described in this disclosure can be implemented to realize one or more of the following potential advantages. In some examples, by utilizing a token-based ATSSS architecture that omits an N3IWF or a similar entity, the described techniques can be used to implement efficient ATSSS architectures, thereby resulting in reduced power, computing, and network resources as compared to architectures requiring an N3IWF and/or a similar integrated core network entity and/or function. Additionally, or alternatively, by including a token and/or connection identifier with a connection request transmitted via a non-3GPP access and/or by validating a UE as a trusted user of the non-3GPP access via the token and/or the connection identifier, the techniques described herein may enable secure communications at the network entity (e.g., the UPF entity), thus resulting in reduced signaling overhead that would otherwise be required to establish and/or maintain an IPSec tunnel at a non-3GPP access of a multiple access session.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the 3GPP. 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

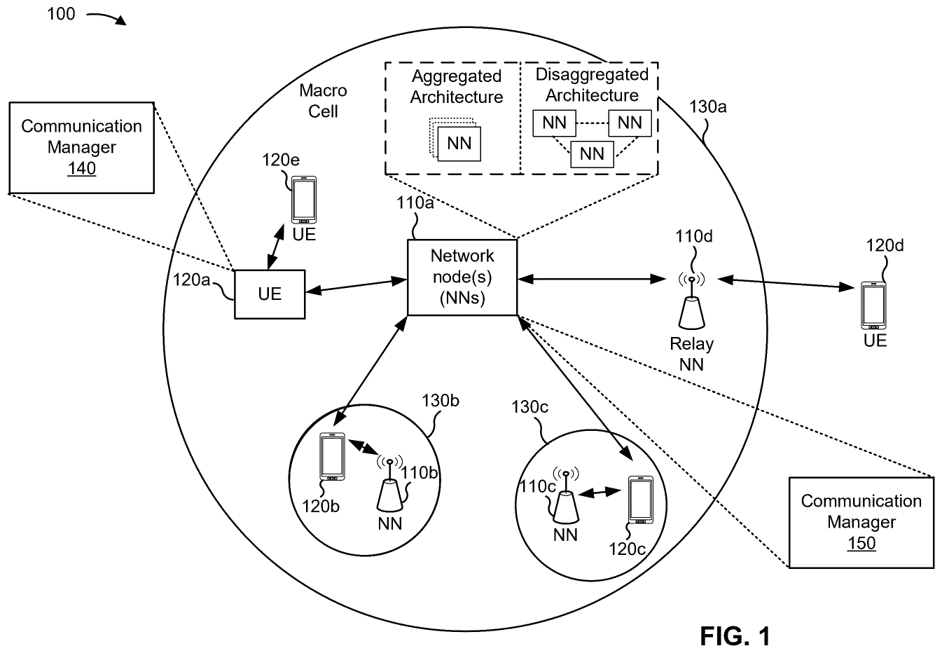

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long-Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may transmit, over a 3GPP access to a network, a request to establish a PDU session for communications between the UE 120 and a network entity, wherein the request to establish the PDU session includes an indication for establishment of connectivity with the network entity via a non-3GPP access to the network, and wherein the PDU session includes a first connection via the 3GPP access and a second connection via the non-3GPP access; receive, from the network, a set of connection parameters for connecting to the network entity via the PDU session, wherein the set of connection parameters includes at least one of a connection identifier, a token, or an IP address of the network entity; establish the first connection with the network entity via the 3GPP access; and establish the second connection with the network entity via the non-3GPP access, wherein establishing the second connection includes transmitting a connection request, via the non-3GPP access, that includes at least one of the token or the connection identifier. Additionally, or alternatively, the communication manager 140 may perform one or more other operations described herein.

In some aspects, the UPF entity described elsewhere herein (e.g., UPF 450) may be associated with the network node 110 (e.g., may be accessible by the UE 120 via an AS interface associated with the network node 110). In such examples, the network node 110 and/or the UPF entity may include a communication manager 150. As described in more detail elsewhere herein, the communication manager 150 may establish, with a UE, a first connection of a PDU session for communications between the UE and the UPF entity, wherein the PDU session includes the first connection via a 3GPP access to the network and a second connection via a non-3GPP access to the network; and establish, with the UE, the second connection of the PDU session, wherein establishing the second connection includes: receiving, via the non-3GPP access, a connection request that includes at least one of a token or a connection identifier, and validating the UE as a trusted user of the non-3GPP access based at least in part on the at least one of the token or the connection identifier. Additionally, or alternatively, the communication manager 150 may perform one or more other operations described herein.

In some aspects, the SMF entity described elsewhere herein (e.g., SMF 445) may be associated with the network node 110 (e.g., may be accessible by the UE 120 via an AS interface associated with the network node 110). In such examples, the network node 110 and/or the SMF entity may include a communication manager 150. As described in more detail elsewhere herein, the communication manager 150 may receive, from a UE over a 3GPP access to the network, a request to establish a PDU session for communications between the UE and a network entity, wherein the request to establish the PDU session includes an indication for establishment of connectivity with the network entity via a non-3GPP access to the network, and wherein the PDU session includes a first connection via a the 3GPP access and a second connection via the non-3GPP access; and transmit, to the UE, a set of connection parameters for connecting to the network entity via the PDU session, wherein the set of connection parameters includes an IP address of the network entity, and wherein at least one of the request to establish the PDU session includes a token that is used to establish the second connection via the non-3GPP access, or the set of connection parameters includes at least one of the token or a connection identifier that is used to establish the second connection via the non-3GPP access. Additionally, or alternatively, the communication manager 150 may perform one or more other operations described herein.

As indicated above, FIG. 1 is provided as an example. Other examples may differ from what is described with regard to FIG. 1.

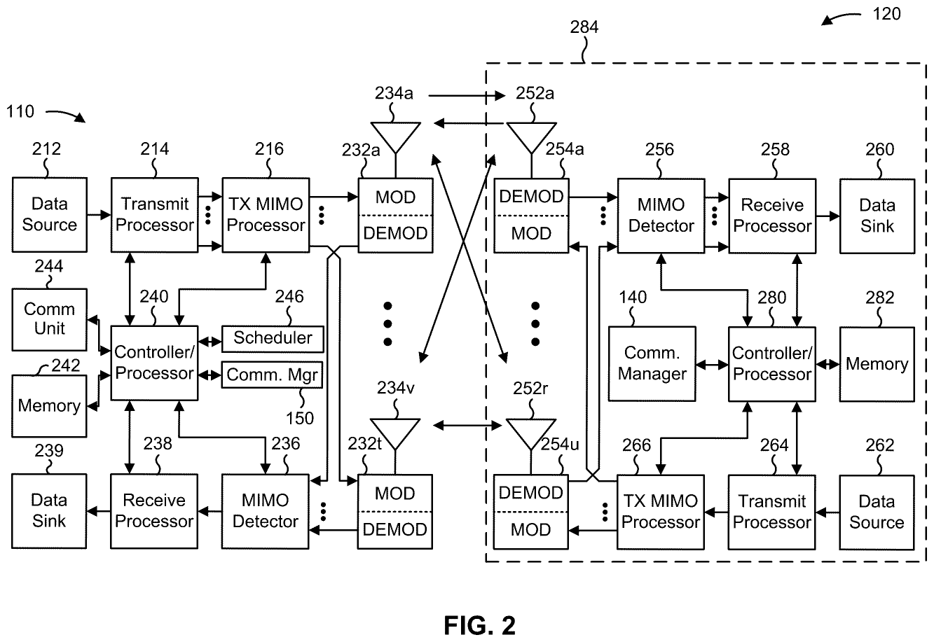

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

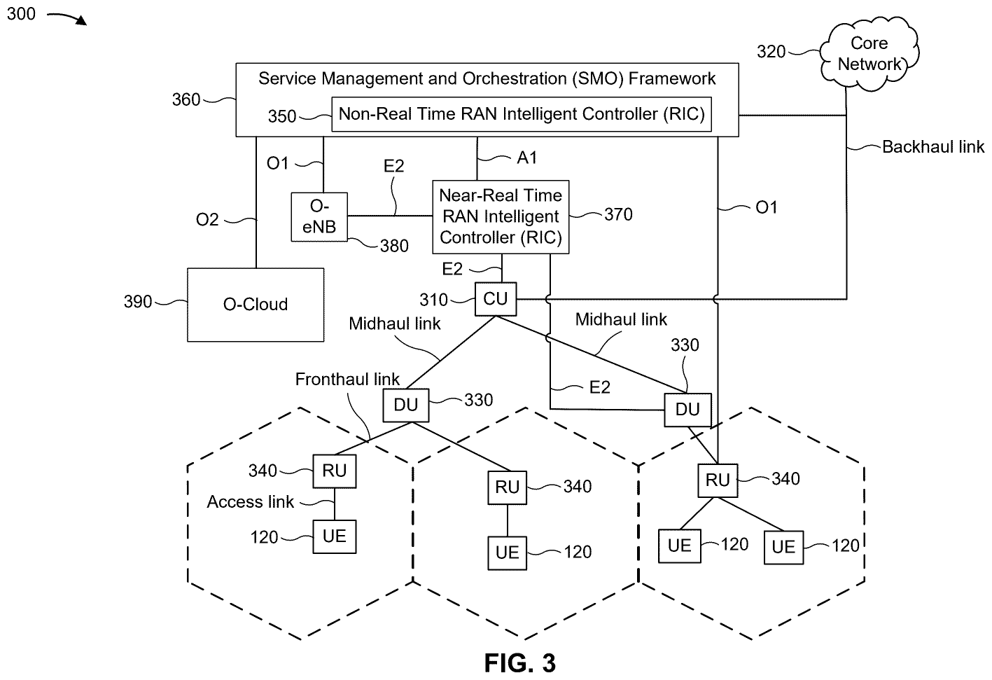

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

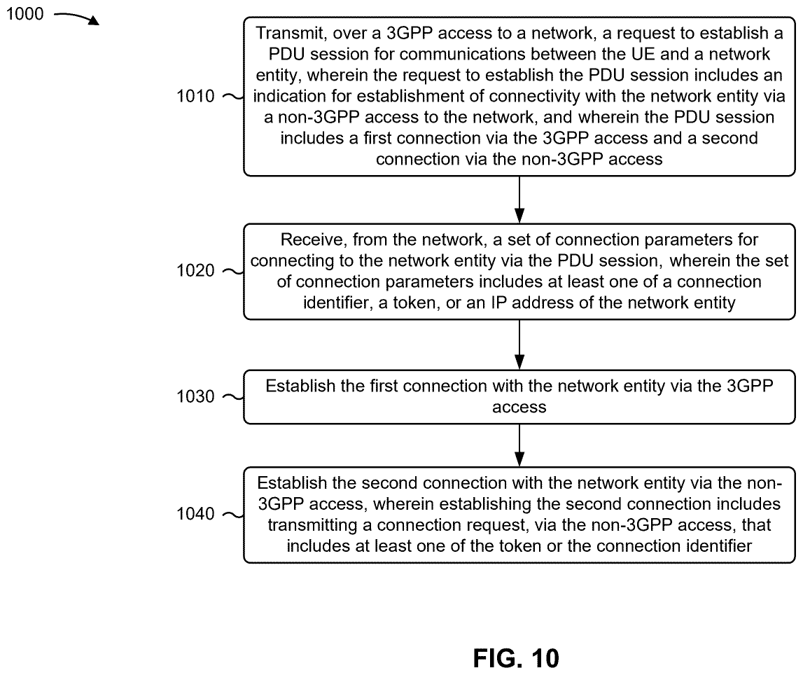

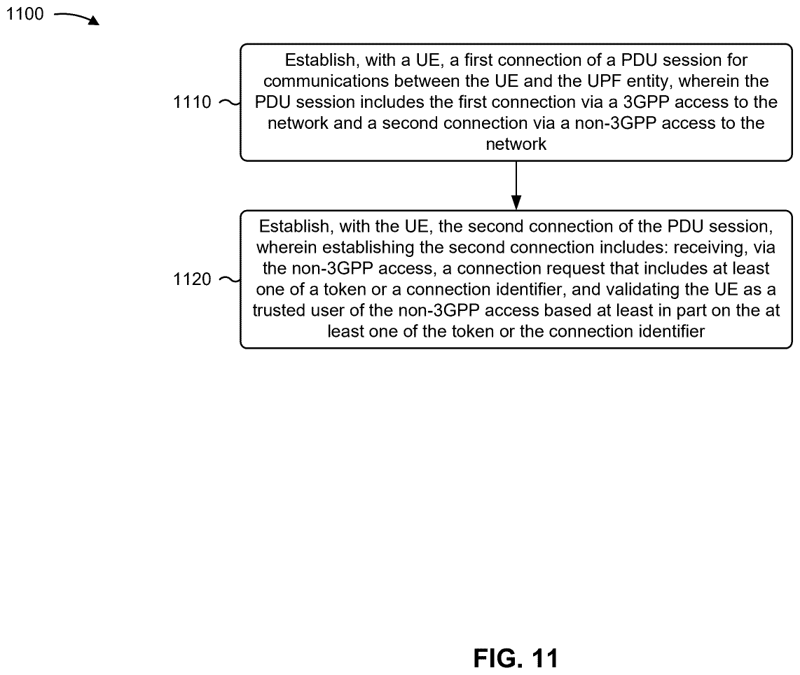

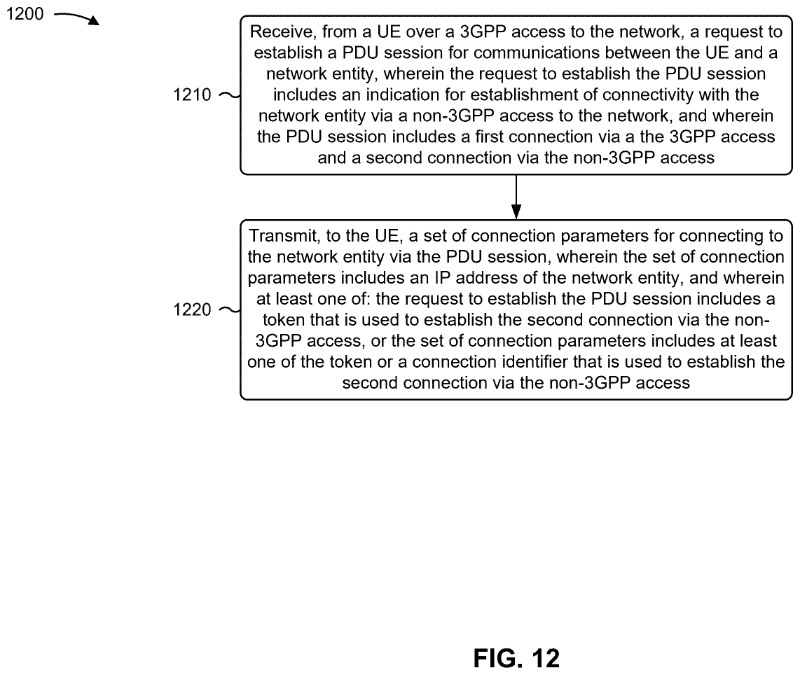

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with enabling token-based connections for an ATSSS architecture, as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 1000 of FIG. 10, process 1100 of FIG. 11, process 1200 of FIG. 12, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1000 of FIG. 10, process 1100 of FIG. 11, process 1200 of FIG. 12, or other processes as described herein. In some examples, executing instructions may include running the instructions, converting the instructions, compiling the instructions, and/or interpreting the instructions, among other examples.

In some aspects, the UE 120 includes means for transmitting, over a 3GPP access to a network, a request to establish a PDU session for communications between the apparatus and a network entity, wherein the request to establish the PDU session includes an indication for establishment of connectivity with the network entity via a non-3GPP access to the network, and wherein the PDU session includes a first connection via the 3GPP access and a second connection via the non-3GPP access; means for receiving, from the network, a set of connection parameters for connecting to the network entity via the PDU session, wherein the set of connection parameters includes at least one of a connection identifier, a token, or an IP address of the network entity; means for establishing the first connection with the network entity via the 3GPP access; and/or means for establishing the second connection with the network entity via the non-3GPP access, wherein the means for establishing the second connection includes means for transmitting a connection request, via the non-3GPP access, that includes at least one of the token or the connection identifier. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UPF entity described elsewhere herein (e.g., UPF 450) includes means for establishing, with a UE, a first connection of a PDU session for communications between the UE and the apparatus, wherein the PDU session includes the first connection via a 3GPP access to a network and a second connection via a non-3GPP access to the network; and means for establishing, with the UE, the second connection of the PDU session, wherein the means for establishing the second connection includes: means for receiving, via the non-3GPP access, a connection request that includes at least one of a token or a connection identifier, and means for validating the UE as a trusted user of the non-3GPP access based at least in part on the at least one of the token or the connection identifier. In some aspects, the means for the UPF entity to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

In some aspects, the SMF entity described elsewhere herein (e.g., SMF 445) includes means for receiving, from a UE over a 3GPP access to a network, a request to establish a PDU session for communications between the UE and a network entity, wherein the request to establish the PDU session includes an indication for establishment of connectivity with the network entity via a non-3GPP access to the network, and wherein the PDU session includes a first connection via the 3GPP access and a second connection via the non-3GPP access; and means for transmitting, to the UE, a set of connection parameters for connecting to the network entity via the PDU session, wherein the set of connection parameters includes an IP address of the network entity, and wherein at least one of: the request to establish the PDU session includes a token that is used to establish the second connection via the non-3GPP access, or the set of connection parameters includes at least one of the token or a connection identifier that is used to establish the second connection via the non-3GPP access. In some aspects, the means for the SMF entity to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

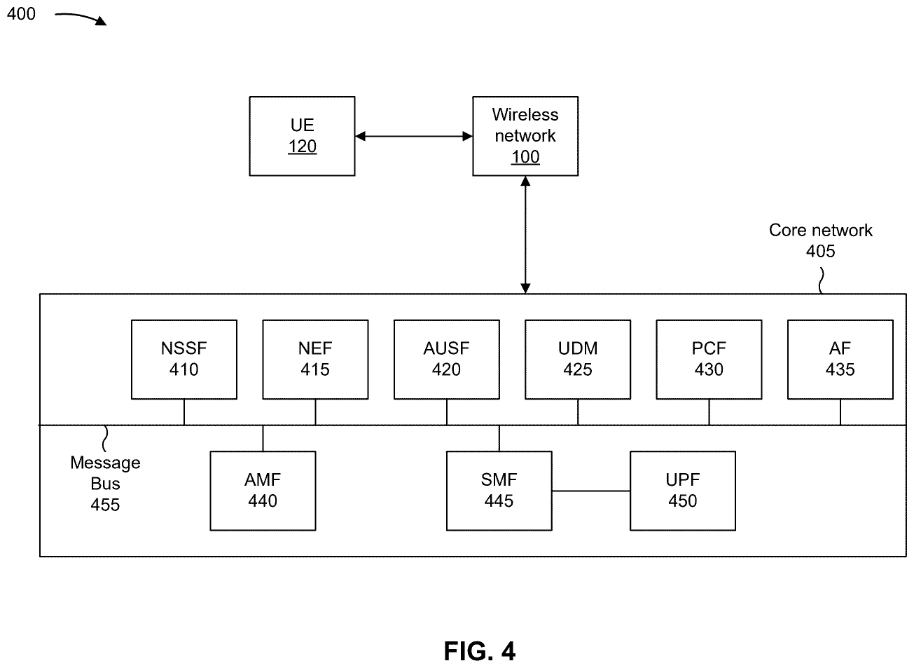

FIG. 4 is a diagram of an example 400 of a core network 405, in accordance with the present disclosure. As shown in FIG. 4, example 400 may include a UE 120, a wireless communication network 100, and the core network 405. Devices (e.g., core network entities) and/or networks of example 400 may interconnect via wired connections, wireless connections, or a combination thereof.

The UE 120 may include one or more devices capable of receiving, generating, storing, processing, and/or providing information, such as information described herein. For example, the UE 120 may include a mobile phone (e.g., a smart phone or a radiotelephone, among other examples), a laptop computer, a tablet computer, a desktop computer, a handheld computer, a gaming device, a wearable communication device (e.g., a smart watch or a pair of smart glasses, among other examples), a mobile hotspot device, a fixed wireless access device, customer premises equipment, an autonomous vehicle, or a similar type of device.

The wireless communication network 100 may support, for example, a cellular RAT. The wireless communication network 100 may include one or more network entities, such as network nodes (e.g., base transceiver stations, radio base stations, node Bs, eNBs, gNBs, base station subsystems, cellular sites, cellular towers, access points, TRPs, radio access nodes, macrocell base stations, microcell base stations, picocell base stations, femtocell base stations, RUs, DUs, CUs, or similar types of devices) and other network entities that can support wireless communication for the UE 120. The wireless communication network 100 may transfer traffic between the UE 120 (e.g., using a 3GPP or cellular RAT) on a 3GPP access path (sometimes referred to herein as a 3GPP access (3GPPA)), one or more network nodes (e.g., using a wireless interface or a backhaul interface, such as a wired backhaul interface), and/or the core network 405. The wireless communication network 100 may provide one or more cells that cover geographic areas. In some aspects, the wireless communication network 100 may transfer traffic between the UE 120, one or more network nodes, and/or the core network 405 using a non-3GPP or non-cellular RAT on a non-3GPP access path (sometimes referred to herein as a non-3GPP access and/or an NIN3A).

In some aspects, the wireless communication network 100 may perform scheduling and/or resource management for the UE 120 covered by the wireless communication network 100 (e.g., the UE 120 covered by a cell provided by the wireless communication network 100). In some aspects, the wireless communication network 100 may be controlled or coordinated by a network controller, which may perform load balancing and/or network-level configuration, among other examples. As The network controller may communicate with the wireless communication network 100 via a wireless or wireline backhaul. In some aspects, the wireless communication network 100 may include a network controller, a self-organizing network (SON) module or component, or a similar module or component. Accordingly, the wireless communication network 100 may perform network control, scheduling, and/or network management functions (e.g., for uplink, downlink, and/or sidelink communications of the UE 120 covered by the wireless communication network 100).

In some aspects, the core network 405 may include an example functional architecture in which systems and/or methods described herein may be implemented. For example, the core network 405 may include an example architecture of a 5G core (5GC) network included in a 5G wireless telecommunications system. Although the example architecture of the core network 405 shown in FIG. 4 may be an example of a service-based architecture, in some aspects, the core network 405 may be implemented as a reference-point architecture and/or a 4G core network, among other examples.

As shown in FIG. 4, the core network 405 may include a number of functional elements in devices (e.g., network entities). The functional elements may include, for example, a network slice selection function (NSSF) 410, a network exposure function (NEF) 415, an authentication server function (AUSF) 420, a unified data management (UDM) component 425, a policy control function (PCF) 430, an application function (AF) 435, an access and mobility management function (AMF) 440, an SMF 445, and/or a UPF 450, among other examples. These functional elements may be communicatively connected via a message bus 455. Each of the functional elements shown in FIG. 4 may be implemented on one or more devices associated with a wireless telecommunications system. In some implementations, one or more of the functional elements may be implemented on physical devices, such as an access point, a base station, and/or a gateway, among other examples. In some implementations, one or more of the functional elements may be implemented on a computing device of a cloud computing environment.

The NSSF 410 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 and/or communications to and from the UE 120. Network slicing may efficiently provide communications for different types of services with different service standards.

The NSSF 410 may determine a set of network slice policies to be applied at the wireless communication network 100. For example, the NSSF 410 may apply one or more UE route selection policy (URSP) rules. In some aspects, the NSSF 410 may select a network slice based on a mapping of a data network name (DNN) field included in a route selection description (RSD) to the DNN field included in a traffic descriptor selected by the UE 120. By providing network slicing, the NSSF 410 allows an operator to deploy multiple substantially independent end-to-end networks potentially with the same infrastructure. In some implementations, each slice may be customized for different services.

The NEF 415 may include one or more devices that support exposure of capabilities and/or events in the wireless telecommunications system to help other entities in the wireless telecommunications system discover network services. The AUSF 420 may include one or more devices that act as an authentication server and support the process of authenticating the UE 120 in the wireless telecommunications system.

The UDM 425 may include one or more devices that store user data and profiles in the wireless telecommunications system. In some aspects, the UDM 425 may be used for fixed access and/or mobile access, among other examples, in the core network 405.

The PCF 430 may include one or more devices that provide a policy framework that incorporates network slicing, roaming, packet processing, and/or mobility management, among other examples. In some aspects, the PCF 430 may include one or more URSP rules used by the NSSF 410 to select network slice instances for the UE 120.

The AF 435 may include one or more devices that support application influence on traffic routing, access to the NEF 415, and/or policy control, among other examples. The AMF 440 may include one or more devices that act as a termination point for non-access stratum (NAS) signaling and/or mobility management, among other examples. In some aspects, the AMF may request that the NSSF 410 select network slice instances for the UE 120 (e.g., at least partially in response to a request for data service from the UE 120).

The SMF 445 may include one or more devices that support the establishment, modification, and release of communication sessions in the wireless telecommunications system. For example, the SMF 445 may configure traffic steering policies at the UPF 450 and/or enforce UE IP address allocation and policies, among other examples. In some aspects, the SMF 445 may provision the network slice instances selected by the NSSF 410 for the UE 120.

The UPF 450 may include one or more devices that serve as an anchor point for intra-RAT and/or inter-RAT mobility. In some aspects, the UPF 450 may apply rules to packets, such as rules pertaining to packet routing, traffic reporting, and/or handling user plane quality of service (QoS), among other examples.

The message bus 455 may be a logical and/or physical communication structure for communication among the functional elements. Accordingly, the message bus 455 may permit communication between two or more functional elements, whether logically (e.g., using one or more application programming interfaces (APIs), among other examples) and/or physically (e.g., using one or more wired and/or wireless connections).

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of example 400 may perform one or more functions described as being performed by another set of devices of example environment 400.

As indicated above, FIG. 4 is provided as an example. Other examples may differ from what is described with regard to FIG. 4.

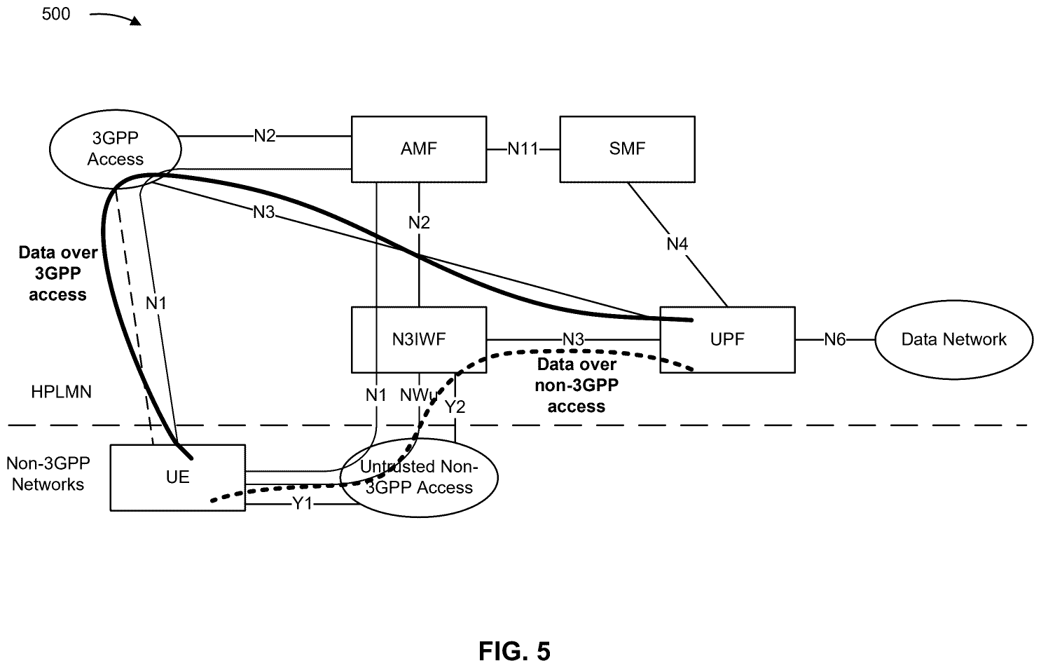

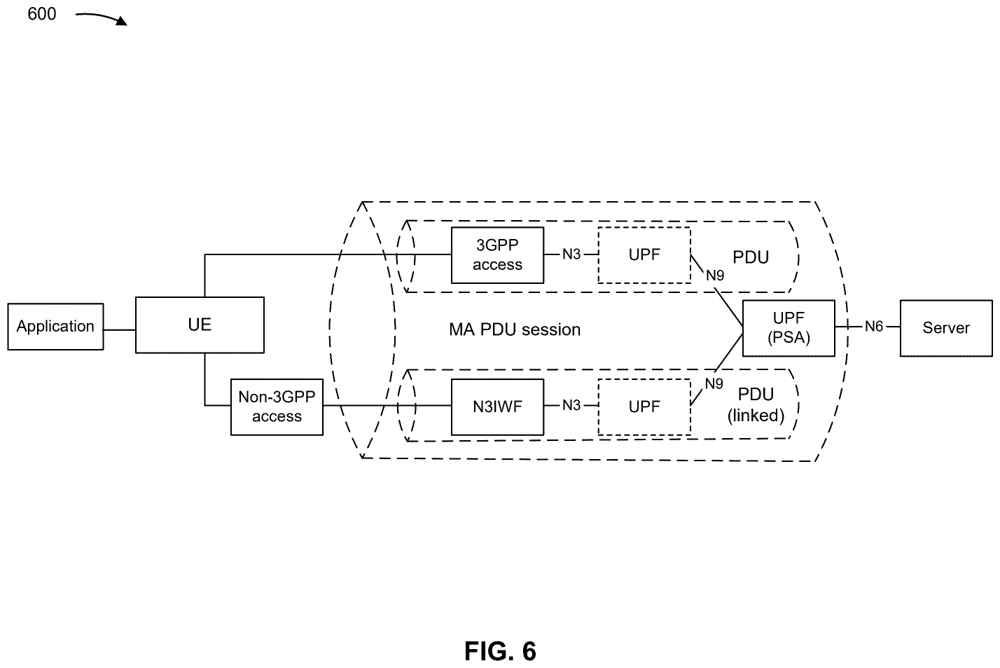

FIG. 5 is a diagram illustrating an example 500 of an ATSSS architecture, in accordance with the present disclosure. In general, as described herein, the ATSSS architecture may integrate a 3GPP access (e.g., a 5G NR cellular access) with a non-3GPP access (e.g., a Wi-Fi and/or wireline access) to allow traffic steering across multiple accesses at a finer granularity than a PDU session. For example, as described in connection with FIG. 6, the ATSSS architecture may support a multi-access (MA) PDU session (sometimes referred to herein more generally as a multiple access session and/or a multi-access session), which may include downlink and/or uplink traffic that is served over one or more concurrent accesses (e.g., the 3GPP access, a trusted non-3GPP access, and/or an untrusted non-3GPP access). For example, in order to improve end user experience, the MA PDU session may be configured for steering such that traffic associated with the MA PDU session is served over either the 3GPP access or the non-3GPP access (e.g., to select the best network), for switching such that traffic associated with the MA PDU session is moved from the 3GPP access to the non-3GPP access or vice versa (e.g., to enable seamless handover), and/or for switching such that traffic associated with the MA PDU session is served concurrently over the 3GPP access and the non-3GPP access (e.g., to enable network aggregation).

Accordingly, as shown in FIG. 5, the ATSSS architecture may enable a UE to use the 3GPP access (e.g., via a home public land mobile network (HPLMN)) and/or the non-3GPP access (e.g., via one or more non-3GPP networks) to access a data network via one or more devices in a 5G core network. For example, as shown in FIG. 5, an AMF may communicate with a UE over an N1 interface and may control one or more access paths with signaling over an N2 interface. Furthermore, as described herein, the ATSSS architecture includes an integrated non-3GPP access (e.g., which may include an integrated core network device to manage a non-3GPP access to the core network, such as an N3IWF entity as shown in FIG. 5, which is described in more detail below in connection with FIG. 6). For example, as shown in FIG. 5, the 3GPP access and the non-3GPP access each have an N3 interface to enable communication with a UPF in the 5G core network, the 3GPP access and the non-3GPP access both provide transparent N1 interfaces from the UE to the AMF (e.g., to transfer UE information related to connection, mobility, and sessions in a manner that is transparent to the 3GPP access and/or the non-3GPP access), and the 3GPP access and the non-3GPP access each have an N2 interface that connects one or more network nodes to the AMF (e.g., to transfer control plane signaling between the AMF and the 3GPP access and/or the non-3GPP access). Furthermore, as shown, the ATSSS architecture includes an SMF that may communicate with the UPF over an N4 interface, an N6 interface to enable communication between the UPF and the data network, and an N11 interface to enable communication between the AMF and the SMF. In some examples, the ATSSS architecture may include an NWu interface between the UE and the N31WF for establishing secure tunnels between the UE and the N31WF so that control-plane and user-plane traffic between the UE and the 5G core network is transferred securely over untrusted non-3GPP access. The ATSSS architecture may further include, for transmitting NWu traffic, a Y1 interface between the UE and an untrusted non-3GPP access entity (e.g., a wireless local-area network (WLAN) entity), and/or a Y2 interface between the untrusted non-3GPP access entity and the N3IWF.

As indicated above, FIG. 5 is provided as an example. Other examples may differ from what is described with regard to FIG. 5.

FIG. 6 is a diagram illustrating an example 600 of an MA PDU session in an ATSSS architecture, in accordance with the present disclosure. For example, as shown in FIG. 6, the ATSSS architecture may generally enable an MA PDU connectivity service that can be used to exchange one or more PDUs between a data network and an application running on a UE using a 3GPP access network and an integrated non-3GPP access network (e.g., Wi-Fi) and two independent N3/N9 tunnels between a UPF PDU session anchor (PSA) and the respective access networks.

As shown in example 600, the MA PDU connectivity service may be realized by establishing an MA PDU session that may have user plane resources on two access networks. For example, in some aspects, the UE may request an MA PDU session when the UE is registered via both the 3GPP access and the non-3GPP access, or when the UE is registered via one access only. After the MA PDU session is established, and when there are user plane resources on both the 3GPP access and the non-3GPP access, the UE may apply a network-provided policy (e.g., ATSSS rules) and/or consider local conditions (e.g., network interface availability, signal loss conditions, user preferences, or the like) to decide how to distribute uplink traffic across the two access networks. Similarly, the UPF PSA may apply a network-provided policy (e.g., N4 interface rules) and/or feedback information received from the UE via the user plane (e.g., access network unavailability or availability) to decide how to distribute downlink traffic across the two independent N3/N9 tunnels and the two access networks. When there are user plane resources on only one access network, the UE may apply the ATSSS rules and consider local conditions to trigger the establishment or activation of the user plane resources over another access.

As described herein, the MA PDU session relies upon an integrated non-3GPP access, which requires the N3IWF to provide an interface between the non-3GPP access network and core network devices. For example, the N3IWF is used to support IPsec tunnel establishment with the UE (e.g., terminating internet key exchange (IKE) and/or IPsec protocols with the UE over the NWu interface and relaying information over the N2 interface to authenticate the UE and authorize the UE to access the core network). In addition, the N3IWF is used to terminate N2 and N3 interfaces to the core network for control plane traffic and user plane traffic, relay uplink and downlink control plane non-access stratum (NAS) signaling between the UE and an AMF via the N1 interface, handle N2 signaling from an SMF (relayed by an AMF) related to PDU sessions and quality of service (QoS), and/or relay uplink and downlink user plane packets between the UE and UPF (e.g., by encapsulating and/or decapsulating packets for IPsec and N3 tunnelling), among other examples. However, the need to deploy the N3IWF poses various practical challenges, including significant complexity to support control plane signaling between the non-3GPP access and the AMF in the core network and/or the need to establish encryption between the UE and the N3IWF.

Accordingly, because there are various practical considerations that have limited or prevented network operators from deploying full-featured ATSSS architectures, some aspects described herein relate to one or more network architectures that may support non-integrated traffic aggregation, steering, and switching for a PDU session. For example, some aspects described herein relate to one or more network architectures that may support traffic aggregation, steering, and switching between a 3GPP access and a non-integrated IP network (e.g., non-integrated Wi-Fi). As described in further detail herein, the one or more network architectures (which may be referred to as ATSSS-Lite or other suitable terminology) may avoid a need to deploy an N3IWF to support integration between a 3GPP access and a non-3GPP access, may achieve at least some of the objectives of ATSSS network architectures (e.g., traffic aggregation), and/or may enable initial deployment of ATSSS features with fewer practical hurdles than a full-featured ATSSS architecture to facilitate a path toward eventual deployment of the full-featured ATSSS network architectures.

As indicated above, FIG. 6 is provided as an example. Other examples may differ from what is described with regard to FIG. 6.

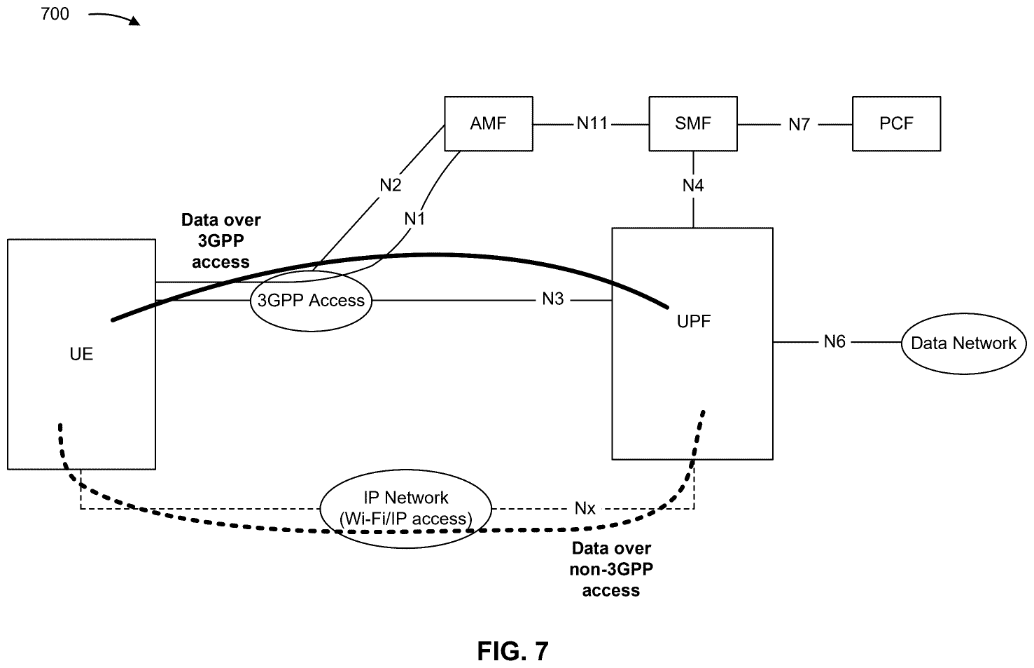

FIG. 7 is a diagram illustrating an example 700 associated with an ATSSS-Lite architecture, in accordance with the present disclosure. For example, example 700 is associated with a network architecture that supports traffic aggregation, steering, and switching for a PDU session across a 3GPP access and a non-integrated IP network (e.g., a generic IP access, such as Wi-Fi or another IP access available to the UE).

More particularly, a UE may access a data network connected to a UPF via a 3GPP access, where the 3GPP access provides an N1 interface to enable communication between the UE and an AMF and the 3GPP access also terminates an N2 interface used to communicate control signaling between the 3GPP access and the AMF. The UPF may communicate with the data network over an N6 interface, may communicate with the UE via the 3GPP access over an N3 interface, and/or may communicate with the UE via the non-integrated IP network (e.g., over the non-3GPP access) over an Nx interface (sometimes referred to herein as an NIN3A). Furthermore, as shown, the ATSSS-Lite architecture may include an SMF that may communicate with the UPF over an N4 interface, a PCF that may communicate with the SMF over an N7 interface, and/or an N11 interface to enable communication between the AMF and the SMF. As may be seen by comparing the example ATSSS-Lite architecture shown in FIG. 7 with the example ATSSS architecture shown in FIG. 5, in ATSSS-Lite the N3IWF entity (or else a similar entity, such as a TNGF entity) is removed and is not replaced with any new network function. Instead, traffic transmitted via the Nx interface (e.g., the NIN3A) may be transmitted to the UPF via the Internet.

In some examples, the UE may access one or more proxies in the UPF using the N3 interface associated with the 3GPP access and/or using the Nx interface associated with the non-3GPP access. In some examples, the one or more proxies in the UPF may include a multipath protocol proxy, such as a multipath transmission control protocol (MPTCP) proxy or a multipath QUIC (MPQUIC) proxy, among other examples. More particularly, the one or more proxies in the UPF may include an MPTCP proxy, which may have two IP addresses to communicate with MPTCP functionality in the UE (e.g., a first IP address to communicate with the MPTCP functionality in the UE via the 3GPP access over the N3 interface and a second IP address to communicate with the MPTCP functionality in the UE via the IP network over the Nx interface). Additionally, or alternatively, the one or more proxies in the UPF may include an MPQUIC proxy. QUIC is a transport layer protocol that is built on top of the user datagram protocol (UDP) instead of a transmission control protocol (TCP), which may reduce latency and/or improve reliability. MPQUIC may extend QUIC by enabling multipath capabilities. In that regard, MPQUIC may utilize multiple network paths (e.g., a 3GPP access path and a non-3GPP access path) simultaneously to transmit data packets between endpoints.

In the ATSSS-Lite architecture shown in FIG. 7, the IP network does not include an N1 interface or an N2 interface, and thus the IP network is non-integrated with respect to the 3GPP access (e.g., no control plane traffic is transferred over the IP network). Accordingly, in contrast to an MA PDU session that requires an N3IWF and/or a TNGF in a full-featured ATSSS architecture, the ATSSS-Lite architecture shown in FIG. 7 may enable a PDU session in which downlink and/or uplink user plane traffic is steered, switched, and/or split across the 3GPP access via the N3 interface and/or the non-3GPP access via the Nx interface (e.g., the NIN3A). Additionally, or alternatively, for UE-to-UPF communication over the Nx interface (e.g., the NIN3A), an IPSec tunnel may disappear, and thus confidentiality and/or integrity of the UE-to-UPF communications may be protected by a transport layer security (TLS) connection, among other examples.

In some examples, filtering mechanisms associated with an N6 interface (e.g., an interface connecting the UPF to the data network as shown in FIG. 5 and/or FIG. 7) may allow incoming (e.g., downlink) traffic based on the UE-generated outgoing (e.g., uplink) traffic. For example, based on a UE transmitting uplink traffic, the UPF may store an IP address associated with the UE as a known (e.g., trusted) address. Accordingly, when responsive traffic is received from the data network over the N6 interface, the UPF may match the incoming traffic against the known IP address associated with the UE. In that regard, a UE may be required to transmit uplink traffic prior to the AS transmitting downlink traffic. Such filtering mechanisms may not work for certain multi-access scenarios, such as the ATSSS-Lite architecture shown in FIG. 7, because incoming traffic at the UPF over the Nx interface (e.g., the NIN3A) is uplink traffic from the UE, and thus the UPF cannot match the traffic against any known IP addresses. On the other hand, if the UPF were to accept incoming traffic over the Nx interface from any entity, the UPF may be vulnerable to attacks. Accordingly, a network may forgo use of the certain multi-access architectures (such as the ATSSS-Lite architecture shown in FIG. 7) in order to ensure secure communications (e.g., the network may employ ATSSS architectures which employ a N3IWF and/or a TNGF), which may result in more complex deployments and thus high power, computing, and network resource consumption, as well as high overhead associated with establishing and/or maintaining an IPSec tunnel.

Some techniques and implementations described herein may enable filtering of incoming traffic at a UPF entity, such as filtering of incoming traffic over an Nx interface (e.g., an NIN3A) and/or filtering of incoming traffic at a UPF entity employed as part of an ATSSS-Lite architecture. In some aspects, a UE may request establishment of a PDU session for communications between the UE and a network entity (e.g., a UPF), with the PDU session including a first connection via a 3GPP access and a second connection via a non-3GPP access (e.g., the UE may request establishment of a PDU session using an ATSSS architecture, such as an ATSSS-Lite architecture). In response, the UE may receive, from the network (e.g., an SMF entity of the network), a set of connection parameters for connecting to a network entity via the PDU session, such as a connection identifier, a token, and/or IP address of the network entity. In aspects involving the token, the token may be generated by a core network entity (e.g., the SMF entity or a UPF entity) or else may be generated by the UE and provided to the network (e.g., the SMF entity) when the UE requests establishment of the PDU session. The UE may establish the PDU session to the network (e.g., to the UPF entity of the network), such as by establishing the first connection with the network entity via the 3GPP access and by establishing the second connection with the network entity via the non-3GPP access. In some aspects, the UE may establish the second connection by transmitting a connection request, via the non-3GPP access, that includes at least one of the token or the connection identifier, and the network entity (e.g., the UPF entity) may validate the UE as a trusted user of the non-3GPP access based at least in part on the token and/or the connection identifier. As a result, a network may implement more efficient multi-access architectures (such as the ATSSS-Lite architecture shown in FIG. 7) while ensuring secure communications at the UPF entity, thus resulting in less complex multi-access session deployments and thus reduced power, computing, and network resource consumption, as well as reduced signaling overhead that would otherwise be required to establish and/or maintain an IPSec tunnel at a non-3GPP access of a multi-access session.

As indicated above, FIG. 7 is provided as an example. Other examples may differ from what is described with regard to FIG. 7.

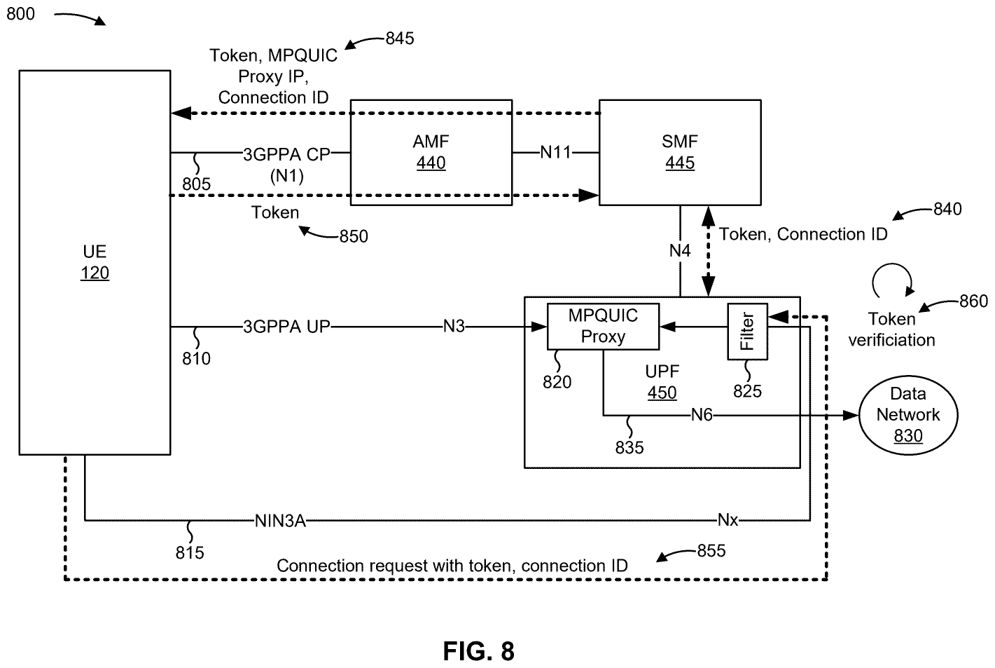

FIG. 8 is a diagram illustrating an example 800 associated with enabling token-based connections for an ATSSS architecture, in accordance with the present disclosure.

As shown in FIG. 8, example 800 includes communications between a UE 120, an AMF 440, an SMF 445, a UPF 450, and/or a data network 830. In some aspects, the UE 120, the AMF 440, the SMF 445, and/or the UPF 450 may be included in a wireless network, such as the wireless communication network 100. As described in more detail below, in some aspects the UE 120 and the UPF 450 may be configured to communicate via a PDU session in order to provide connectivity between the UE 120 and the data network 830. For example, the UE 120 may be in communication with the AMF 440 via a 3GPPA control plane (CP) (e.g., an N1 interface), as indicated by reference number 805. The UE 120 and/or the SMF 445 (via the AMF 440) may use the 3GPPA CP in order to establish the PDU session, among other examples.

The UE 120 and the UPF 450 may be configured to communicate using the PDU session, such as via a first connection associated with a 3GPPA user plane (UP) (e.g., an N3 interface), as indicated by reference number 810, and/or via a second connection associated with a non-3GPP access (e.g., a NIN3A and/or an Nx interface), as indicated by reference number 815. The first connection and/or the second connection may terminate at a proxy associated with UPF 450, such as a multipath protocol proxy. The UPF 450 in FIG. 8 is shown as including an MPQUIC proxy 820 as one example of a multipath protocol proxy, but, in some other aspects, the UPF 450 may include a different type of multipath protocol proxy, such as a MPTCP proxy, among other examples. For ease of description, the features associated with the multipath protocol proxy are described as being performed by the MPQUIC proxy 820, but, in some other aspects, features attributed to the MPQUIC proxy may be performed by a different type of multipath protocol proxy (e.g., an MPTCP proxy, among other examples). In some examples, the UPF 450 may include a filter component 825, which may be configured to filter incoming messages via the NIN3A and/or Nx interface such that untrusted and/or unverified traffic does not reach the MPQUIC proxy 820. The UPF 450, and more particularly the MPQUIC proxy 820 of the UPF 450, may be in communication with the data network 830 via an N6 interface, as indicated by reference number 835. In this way, the UPF 450 may serve as a PSA for the 3GPPA and the NIN3A and/or may provide connectivity between the UE 120 and the data network 830 via the multi-access session.

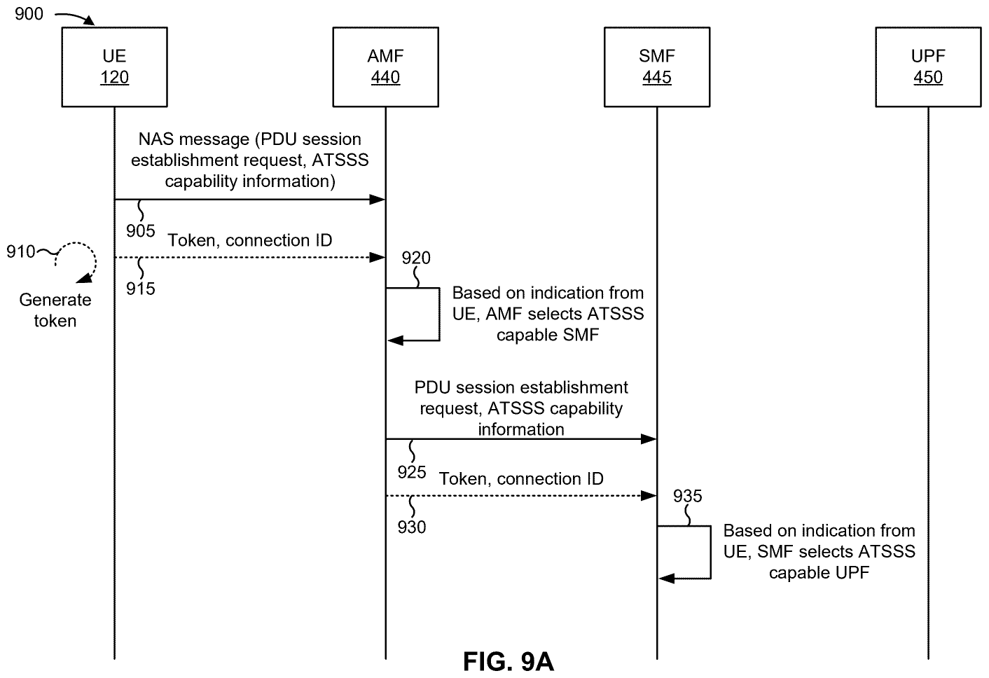

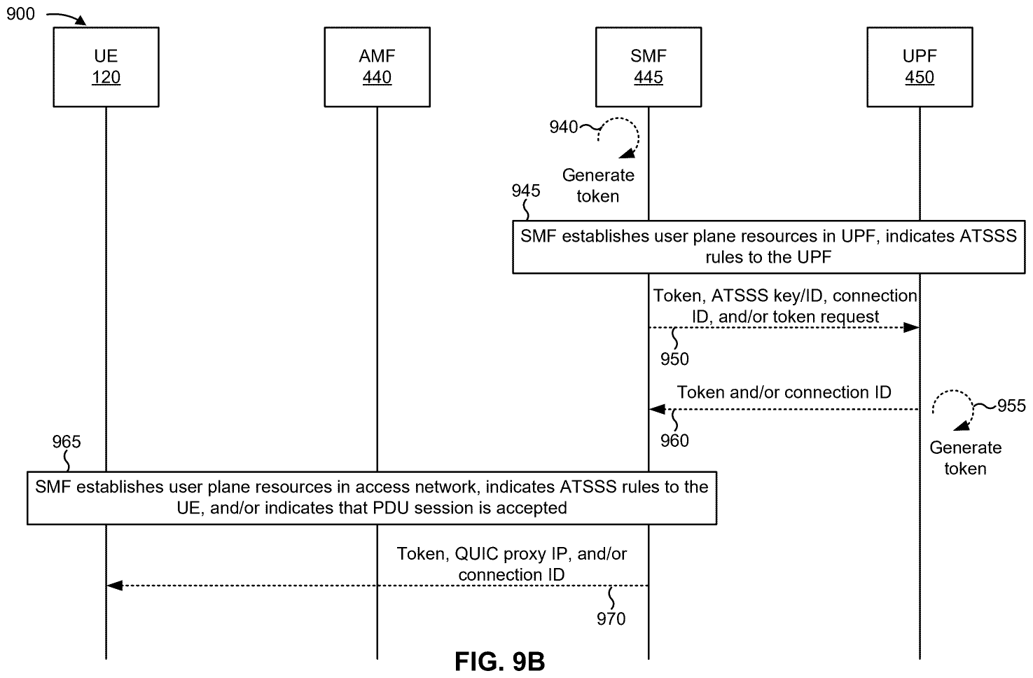

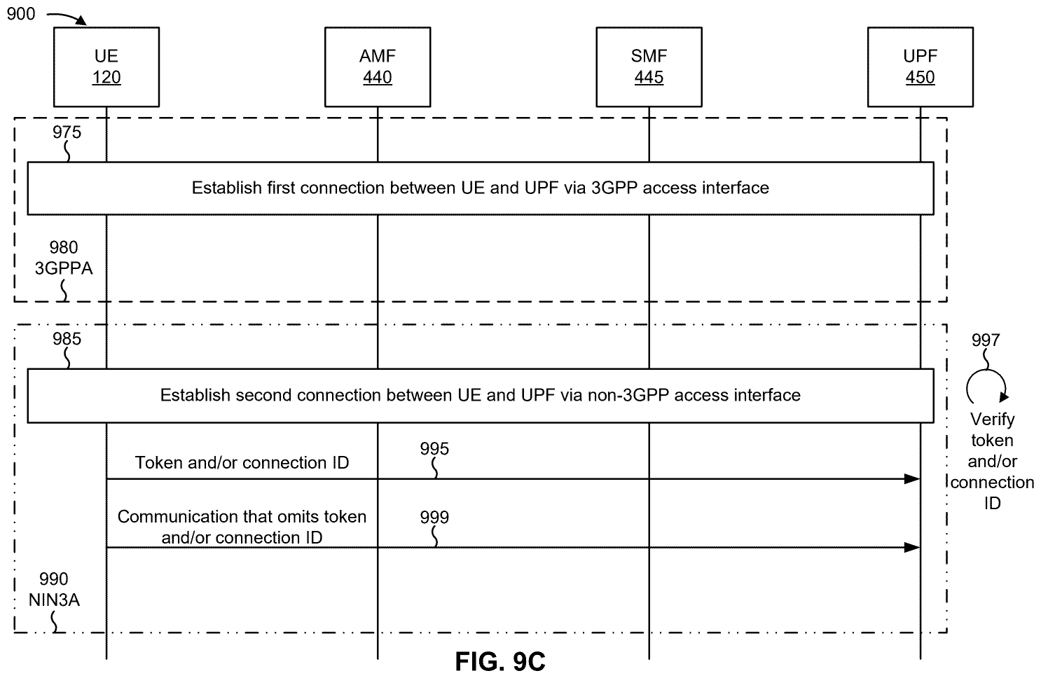

In some aspects, the UPF 450, and more particularly the filter component 825 of the UPF 450, may be configured to validate the UE 120 as a trusted user of the NIN3A by verifying a token and/or connection identifier (ID) that is included by the UE 120 with a first communication (e.g., a connection request) transmitted using the NIN3A. In some aspects, the token and/or a related connection ID may be generated by the SMF 445 and/or the UPF 450. For example, in some aspects, the SMF 445 may generate the token and/or the connection ID. More particularly, in some aspects the SMF 445 may generate the token randomly. In some other aspects, the SMF 445 may generate the token using the connection ID and/or an ATSSS key, which is described in more detail below in connection with FIGS. 9A-9C. In such aspects, as indicated by reference number 840, the SMF 445 may transmit the token, the connection ID, the ATSSS key, and/or similar information to the UPF 450.

In some other aspects, the UPF 450 may generate the token and/or the connection ID. More particularly, in some aspects the SMF 445 (e.g., in response to receiving a PDU session establishment request from the UE 120, or otherwise) may request the UPF 450 to generate the token and/or the connection ID, and thus the UPF 450 may generate the token and/or the connection ID. In some aspects, the UPF 450 may generate the token randomly. In some other aspects, the UPF 450 may generate the token using the connection ID and/or an ATSSS key, which may be provided to the UPF 450 by the SMF 445 via the request to generate the token and/or the connection ID. In such aspects, as indicated by reference number 840, the UPF 450 may transmit the token, the connection ID, and/or similar information to the SMF 445.

As indicated by reference number 845, the SMF 445 may transmit certain connection parameters to the UE 120. For example, the SMF 445 may transmit an IP address associated with the UPF 450, which may be used by the UE 120 to establish a connection with the UPF 450 via the 3GPPA UP and/or via the NIN3A. More particularly, in aspects in which the UPF 450 includes the MPQUIC proxy 820, the IP address may be a QUIC IP address (e.g., an IP address for the MPQUIC proxy 820) and/or may be a public address accessible from the Internet (e.g., such that the UE 120 may access the MPQUIC proxy 820 over the NIN3A using the IP address). Additionally, or alternatively, in aspects in which the SMF 445 and/or the UPF 450 generates the token and/or the connection ID, the connection parameters may further include the token and/or the connection ID.

In some other aspects, and as indicated by reference number 850, the UE 120 may transmit the token to the SMF 445, and the SMF 445 may in turn forward the token to the UPF 450 (e.g., via the signaling shown in connection with reference number 840). For example, the UE 120 may generate the token and then forward the token to the SMF 445 with a PDU establishment message, among other examples. In such aspects, the UE 120 may generate the token randomly. In some other aspects, the UE 120 may generate the token using an identifier associated with the UE 120 (e.g., the connection ID and/or a similar ID) and/or an ATSSS key (which may be provided to the UE 120 by the SMF 445).

The UE 120 may use the token and/or the associated connection ID to establish a connection with the UPF 450 (e.g., the MPQUIC proxy 820 of the UPF 450) via the NIN3A. More particularly, as indicated by reference number 855, the UE 120 may transmit, to the UPF 450 using the NIN3A and/or using the proxy IP address signaled to the UE 120 via the SMF 445 (as described above), a connection request that includes the token and/or the connection ID. Moreover, as indicated by reference number 860, upon receipt of the connection request, the UPF 450 (e.g., the filter component 825 of the UPF 450) may verify the token and/or the connection ID. Put another way, the UPF 450 may verify the token received in the first UP data message transmitted by the UE 120. In aspects in which the UPF 450 verifies the token (and thus verifies that the UE 120 is a trusted user of the NIN3A and/or that traffic received from the UE 120 via the NIN3A is trusted traffic), the UPF 450 may store (e.g., in a data structure, such as a table) an indication that traffic received from the UE 120 is authorized traffic. For example, the UPF 450 may store an IP address and/or port number associated with the UE 120 as an authorized IP address and/or port number. In that regard, the UE 120 may transmit subsequent traffic using the NIN3A, and the UPF 450 (e.g., the filter component 825 of the UPF 450) may permit the traffic to be transmitted to the MPQUIC proxy 820 and thus ultimately to the data network 830 via the N6 interface. Additional aspects of the signaling transmitted between the various entities shown in the architecture of example 800 are described in more detail below in connection with FIGS. 9A-9C.

As indicated above, FIG. 8 is provided as an example. Other examples may differ from what is described with respect to FIG. 8.

FIGS. 9A-9C are diagrams of another example 900 associated with enabling token-based connections for an ATSSS architecture, in accordance with the present disclosure. As shown in FIGS. 9A-9C, a UE 120, an AMF 440, an SMF 445, and/or a UPF 450 may be in communication. In some aspects, the UE 120, the AMF 440, the SMF 445, and/or the UPF 450 may be part of a wireless network (e.g., wireless communication network 100). For example, the AMF 440, the SMF 445, and/or the UPF 450 may be part of a core network (e.g., a 3GPP core network), and/or the UE 120 may be in communication with the core network via one or more network nodes 110 (e.g., one or more base stations, CUs, DUs, and/or RUs). In some aspects, the UE 120 may be configured to communicate with the AMF 440, the SMF 445, and/or the UPF 450 via a multi-access session, such as a PDU session associated with a 3GPPA and a non-3GPPA (e.g., a NIN3A). For example, the UE 120 may be configured to communicate with the UPF 450 using an ATSSS architecture (more particularly, an ATSSS-Lite architecture), such as the ATSSS architecture described above in connection with FIG. 7 and/or FIG. 8. In that regard, in some aspects, the UPF 450 may be within a 3GPP core network and/or may support multiple connections with the UE 120, such as a first connection via a 3GPP access (e.g., a 3GPPA 980, described in more detail below in connection with FIG. 9C), and/or a second connection via a non-3GPP access (e.g., an NIN3A 990, described in more detail below in connection with FIG. 9C).

In some aspects, a network node may transmit, and the UE 120 may receive, configuration information (not shown). In some aspects, the UE 120 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

The UE 120 may configure itself based at least in part on the configuration information. In some aspects, the UE 120 may be configured to perform one or more operations described herein based at least in part on the configuration information.

Additionally, or alternatively, the UE 120 may transmit, and a network node may receive, a capabilities report (not shown). The capabilities report may indicate whether the UE 120 supports a feature and/or one or more parameters related to the feature. For example, the capability information may indicate a capability and/or parameter for communicating using a multi-access session (e.g., a PDU session associated with a 3GPPA and a non-3GPPA). As another example, the capabilities report may indicate a capability and/or parameter for supporting an ATSSS architecture, such as an ATSSS-Lite architecture and/or a token-based ATSSS establishment procedure (e.g., the token-based multi-access session establishment procedure described above in connection with FIG. 8). One or more operations described herein may be based on capability information of the capabilities report. For example, the UE 120 may perform a communication in accordance with the capability information, or may receive configuration information that is in accordance with the capability information. In some aspects, the capabilities report may indicate UE support for generating a token and/or connection ID and/or receiving a token and/or connection ID, and/or establishing a connection with a network entity (e.g., the UPF 450) via a non-3GPP access (e.g., the NIN3A) by including the token and/or connection ID with a first UP transmission transmitted by the UE 120 to the network entity via the non-3GPP access.

In some aspects, the configuration information and/or the capabilities report may include information transmitted via multiple communications. Additionally, or alternatively, a network node may transmit the configuration information, or a communication including at least a portion of the configuration information, before and/or after the UE 120 transmits the capabilities report. For example, the network node may transmit a first portion of the configuration information before the capabilities report, the UE 120 may transmit at least a portion of the capabilities report, and the network node may transmit a second portion of the configuration information after receiving the capabilities report.

As shown in FIG. 9A, and as indicated by reference number 905, the UE 120 may transmit to the AMF 440 (and ultimately the SMF 445) a communication requesting establishment of a multiple access session to a network (e.g., a PDU session), such as establishment of a PDU session that includes a first connection via a 3GPP access (e.g., the 3GPPA 980 described below in connection with FIG. 9C) and a second connection via a non-3GPP access (e.g., the NIN3A 990 described below in connection with FIG. 9C). More particularly, the UE 120 may transmit, and the AMF 440 may receive, a NAS message that includes a PDU session establishment request, ATSSS capability information, and/or similar information. Moreover, as described above in connection with reference number 850 in FIG. 8, in some aspects the UE 120 may generate a token to be used to validate the UE 120 as a trusted user of the non-3GPP access. In such aspects, the UE 120 may generate the token, as indicated by reference number 910, and/or the UE 120 may transmit the token to the network (e.g., to the SMF 445 via the AMF 440) as part of the PDU session establishment procedure, as indicated by reference number 915. In some aspects, the UE 120 may randomly generate the token or else may generate the token based at least in part on an ID (e.g., a connection ID, an IP address, and/or a similar ID) associated with the UE 120, among other examples. In such aspects, the UE 120 may indicate the ID (e.g., a connection ID, an IP address, and/or a similar ID) to the AMF 440 (and thus ultimately the SMF 445) via the signaling shown in connection with reference number 915. In some aspects, the UE 120 may generate the token in a substantially similar manner as described below in connection with the SMF 445 generating a token (which is described in detail in connection with reference number 940).

As indicated by reference number 920, based on the indication received from the UE 120 (e.g., the PDU session establishment request, the ATSSS capability information, the token, the connection ID, and/or similar information), the AMF 440 may select the SMF 445 to be used to establish the PDU session. For example, the AMF 440 may select the SMF 445 based at least in part on the SMF 445 being an ATSSS-capable SMF. Accordingly, as indicated by reference number 925, the AMF 440 may forward, to the SMF 445, the UE 120's request to establish the PDU session. More particularly, the AMF 440 may transmit, and the SMF 445 may receive, the PDU session establishment request, the ATSSS capability information, and/or similar information. Additionally, or alternatively, in aspects in which the UE 120 generates the token, the AMF 440 may transmit, and the SMF 445 may receive, the token and/or related information (e.g., a connection ID, an IP address associated with the UE 120, and/or similar information), as indicated by reference number 930.

As indicated by reference number 935, based on the indication received from the AMF 440 (e.g., the PDU session establishment request, the ATSSS capability information, the token, and/or similar information), the SMF 445 may select the UPF 450 to be used for the PDU session. For example, the SMF 445 may select the UPF 450 based at least in part on the UPF 450 being an ATSSS-capable UPF.

As shown in FIG. 9B, and as indicated by reference number 940, in some aspects the token may be generated by the SMF 445. Put another way, at PDU session establishment, the SMF 445 may generate the token (sometimes referred to as an NIN3A authorization token, which may be a one-time NIN3A authorization token) and/or the SMF 445 may allocate the token to the UE 120. In some aspects, the SMF 445 may generate the token using an ATSSS key, such as an ATSSS key that is specific to a multipath protocol proxy (e.g., an MPQUIC proxy, an MPTCP proxy, and/or a similar proxy) associated with the UPF 450, which may enable stateless filtering (e.g., filtering based solely on the content of individual packets, without requiring consideration of the context and/or the state of the communication session) at the UPF 450 (e.g., by the filter component 825 of the UPF 450), among other examples.

For example, in some aspects, the SMF 445 may generate the token based at least in part on using a hash-based message authentication code (HMAC) using the ATSSS key and a connection ID associated with the UE 120 (and, more particularly, a connection ID associated with the connection between the UE 120 and the UPF 450 over the NIN3A). For example, the connection ID may be a unique ID associated with the UE 120's PDU session assigned by the SMF 445 and/or the UPF 450 (e.g., the MPQUIC proxy 820 of the UPF 450 or a similar multipath protocol proxy of the UPF 450). In some aspects, the connection ID may include a quantity of bits sufficient to identify the PDU session, such as 32 bits or more. Additionally, or alternatively, in some aspects, the connection ID may be carried along with the token when the UE 120 transmits a connection request via the non-3GPP access, which is described in more detail below in connection with reference number 985. In some aspects, the connection ID may be a QUIC protocol connection ID associated with the UE 120. Put another way, a QUIC connection ID associated with the UE 120 and/or assigned to the UE 120 may be reused for a purpose of validating the UE 120 as a trusted user of the non-3GPP access and/or for a purpose of generating the token (e.g., the NIN3A authorization token).

In some aspects, a multipath protocol proxy (e.g., the MPQUIC proxy 820) associated with the UPF 450 may be associated with more than one ATSSS key. In such examples, each ATSSS key may in turn be associated with a corresponding ATSSS key ID, which may be used by the UPF 450 when validating a token received from the UE 120. More particularly, in aspects in which the token is generated by the SMF 445 using a particular key ID (e.g., by using an HMAC based at least in part on the ATSSS key), the UPF 450 may generate a token using the ATSSS key, as indicated by the corresponding ATSSS key ID, as well as additional parameters (e.g., the connection ID, among other examples).

In some aspects, the SMF 445 may generate the token using an HMAC that is based at least in part on an ATSSS key (e.g., identified according to an applicable ATSSS key ID), a multipath protocol proxy IP address (e.g., a public address associated with the MPQUIC proxy 820), and/or multi-session information (e.g., PDU session information, which may include certain UE 120 verification information, such as an IP address associated with the UE 120 if provided to the SMF 445 via the PDU session establishment message, a connection ID associated with the UE 120 and assigned to the UE 120 via the SMF 445 and/or the UPF 450, and/or similar information). Put another way, in some aspects the SMF 445 may generate the token, for a given ATSSS key ID (referred to in the following expression as “KID”), using the expression token=[KID]|HMAC (ATSSS key, multipath protocol proxy IP address, PDU session information).

In some aspects the ATSSS key may be generated by the SMF 445 and/or may not be known to UE 120. Put another way, the core network may not indicate the ATSSS key to the UE 120. Moreover, by generating the token as a function of the multipath protocol proxy IP address, the UE 120's connection over the non-3GPP access may be restricted to an assigned multipath protocol proxy (e.g., the MPQUIC proxy 820). As described above, in some aspects the multi-access session information (e.g., the PDU session information) may include UE 120 verification information. In some aspects, the UE 120 verification information may include an IP address of the UE 120. For example, in aspects in which the UE 120 attempts to add multipath protocol connection over the Nx interface (e.g., the NIN3A 990 described below) with 3GPP access, the UE 120 can inform its IP address over the Nx interface to the SMF 445. In that regard, the UE 120's IP address for the Nx interface may not be used in aspects in which the UE 120's IP address is not informed to the SMF 445 during the PDU session establishment stage. In some other aspects, the UE 120 verification information may include the connection ID, described above.

In some other aspects, the SMF 445 may generate a random token (e.g., a token that is not deterministic based at least in part on an ATSSS key, a multipath protocol proxy IP address, PDU session information, and/or similar information). Put another way, the SMF 445 may generate a token (e.g., a binary string) that does not have a specific structure. In such aspects, the randomly generated token may have a structure that is unpredictable and/or that may uniquely identify (e.g., be associated with) the specific multi-access session (e.g., the PDU session associated with the UE 120). Additionally, or alternatively, in aspects in which the SMF 445 generates the token, the token may be provided to the UE 120 via NAS signaling (described in more detail below in connection with reference number 970) and/or to the UPF 450 in a PDU session configuration message (described in more detail below in connection with reference number 950).

As indicated by reference number 945, based at least in part on the PDU session establishment request, the ATSSS capability information, and/or similar multi-access session establishment information received from the UE 120 (via the AMF 440), the SMF 445 may establish user plane resources in the UPF 450 and/or may indicate ATSSS rules to the UPF 450. Additionally, or alternatively, as indicated by reference number 950, the SMF 445 may transmit an indication of certain information associated with the token (e.g., the NIN3A authorization token) to the UPF 450. For example, in aspects in which the UE 120 generates the token (as described above in connection with reference number 910) or in aspects in which the SMF generates the token (as described above in connection with reference number 940), the SMF 445 may transmit, and the UPF 450 may receive, the token (e.g., the NIN3A authorization token). In some aspects, such as in aspects in which the token is generated based at least in part on an ATSSS key and/or a connection ID, the SMF 445 may additionally, or alternatively, transmit, to the UPF 450, an indication of the ATSSS key, an indication of an ATSSS key ID associated with the ATSSS key, and/or an indication of the connection ID, among other information.

In some other aspects, the UPF 450 may generate the token. In such aspects, the SMF 445 may request the token to be generated by the UPF 450 using the signaling shown in connection with reference number 950. More particularly, in such aspects, the SMF 445 may transmit, and the UPF 450 may receive, a request to generate the token. Moreover, in aspects in which the token is based at least in part on an ATSSS key (e.g., in aspects in which the token is generated using an HMAC associated with the ATSSS key, among other information described above in connection with reference number 940), the SMF 445 may transmit, and the UPF 450 may receive, an indication of an ATSSS key associated with a multipath protocol proxy (e.g., the MPQUIC proxy 820) associated with the UPF 450 and/or an ATSSS key ID associated with the ATSSS key.

In such aspects, the UPF 450 may generate the token, as indicated by reference number 955, which may be performed in a substantially similar manner as described in connection with the SMF 445 generating the token in connection with reference number 940. More particularly, in some aspects, generating the token may include generating the token based at least in part on the ATSSS key, such as by using an HMAC associated with the ATSSS key, the multipath protocol proxy IP address, and/or PDU session information (e.g., a connection ID, an IP address associated with the UE 120, and/or similar information). In such aspects, the ATSSS key may be generated by the SMF 445 and transmitted to the UPF 450, as described above. Additionally, or alternatively, the ATSSS key may be associated with an ATSSS key ID, as described above. That is, in some aspects the SMF may generate multiple ATSSS keys, such as one for each multipath protocol proxy IP address, with a multipath protocol proxy IP address (e.g., for the Nx interface) being configured at PDU session establishment. The ATSSS key may have an ATSSS key ID and/or an associated lifetime, and the SMF 445 may share the ATSSS key and/or the corresponding lifetime with the UPF 450 (e.g., with the MPQUIC proxy 820 of the UPF 450), such as by using the signaling described above in connection with reference number 950. In such aspects, the UPF 450 may use the ATSSS key to generate the token (in a similar manner as described above in connection with reference number 940) and/or the multipath protocol proxy may use the ATSSS key to verify the incoming connection request from the UE 120 via Nx interface, as described in more detail below in connection with reference number 985. In some other aspects, the UPF 450 may generate the token randomly, in a similar manner as described above in connection with reference number 940.

As indicated by reference number 960, in aspects in which the UPF 450 generates the token, the UPF 450 may transmit, and the SMF 445 may receive, the token and/or related information used to generate the token, such as the connection ID, among other information. More particularly, in aspects in which the token is generated using an HMAC associated with the ATSSS key and a connection ID associated with the UE 120 (e.g., a connection ID associated with a non-3GPP access between the UE 120 and the UPF 450), the UPF 450 may indicate the connection ID to the SMF 445, if the connection ID is not already known to the SMF 445 (e.g., in aspects in which the UPF 450, and not the SMF 445, generates and/or allocates connection IDs).

As indicated by reference number 965, the SMF 445, the AMF 440, and/or the UE 120 may establish the multi-access session, such as by establishing a PDU session or a similar session. More particularly, in some aspects, the SMF 445 may establish user plane resources in the access network, the SMF 445 may indicate ATSSS rules to the UE 120, and/or the SMF 445 may indicate to the UE 120 that the PDU session is accepted. Moreover, as indicated by reference number 970, the SMF 445 may transmit, and the UE 120 may receive, a set of connection parameters for connecting to a network entity (e.g., the UPF 450) via the multiple access session. Put another way, the SMF 445 may transmit connection parameters associated with establishing the PDU session, and, more particularly, connection parameters associated with establishing the non-3GPP access connection with the UPF 450 (e.g., the connection over the Nx interface and/or the NIN3A 990). For example, the connection parameters may include a multipath protocol proxy IP address (e.g., a public address accessible from the Internet that may be used to access the MPQUIC proxy 820 of the UPF 450 via the Nx interface). Moreover, in aspects in which the SMF 445 and/or the UPF 450 generates a token and/or a connection ID, the connection parameters may include the token and/or the connection ID.

In aspects in which the connection parameters include the connection ID, the connection ID may be a QUIC protocol connection identifier associated with the UE 120, as described above in connection with reference number 940. Moreover, in some aspects, such as aspects in which the token is randomly generated and thus is not based on a connection ID (e.g., is not generated using an HMAC associated with the connection ID), the connection parameters may include the token but may omit the connection ID. Moreover, in some aspects, such as aspects in which the UE 120 is verified as a trusted user of the non-3GPP access using the connection ID alone (e.g., without a corresponding token), the connection parameters may include the connection ID but may omit the token.

As shown in FIG. 9C, and as indicated by reference number 975, the UE 120 and the UPF 450 (e.g., the MPQUIC proxy 820 of the UPF 450) may establish a first connection of the multi-access session via a 3GPP access, such as the 3GPPA 980 shown in FIG. 9C. For example, the UE 120 may transmit, to the UPF 450 (more particularly, to the MPQUIC proxy 820 of the UPF 450), a connection request via the 3GPPA 980. Moreover, as indicated by reference number 985, the UE 120 and the UPF 450 (e.g., the MPQUIC proxy 820 of the UPF 450) may establish a second connection of the multi-access session via a non-3GPP access, such as the NIN3A 990 shown in FIG. 9C. In some aspects, in order to establish the second connection, the UE 120 may transmit, to the UPF 450 via the non-3GPP access (e.g., the NIN3A 990), a connection request that includes at least one of the token or the connection ID, as indicated by reference number 995.

In some aspects, the connection request transmitted via the non-3GPP access (e.g., the NIN3A 990 and/or the Nx interface) may be a first uplink traffic transmitted by the UE 120 to the UPF 450 via the non-3GPP access. For example, the connection request may be associated with a first IP packet sent to the UPF 450 via the non-3GPP access (e.g., the token and/or the connection ID may be included inside a first IP packet sent to UPF 450 via the non-3GPP access), the connection request may be associated with a TLS HELLO packet (e.g., the token and/or the connection ID may be included inside a TLS HELLO packet), and/or the connection request may be associated with a zero-round-trip-time (0-RTT) packet (e.g., the token and/or the connection ID may be included inside a 0-RTT packet), among other examples.

Moreover, in aspects in which the UE 120 is validated as a trusted user of the non-3GPP access based on a token (e.g., an NIN3A authorization token), the connection request may include the token. Additionally, or alternatively, in aspects in which the token is based at least in part on a connection ID associated with the UE 120 (e.g., in aspects in which the token is generated based at least in part on an HMAC that uses a connection ID associated with the UE 120), the connection request may include the connection ID. Moreover, in aspects in which the UE 120 is validated as a trusted user of the non-3GPP access based on a connection ID alone, the connection request may include the connection ID and/or may omit the token.

Additionally, or alternatively, in some aspects, the UE 120 and the UPF 450 may establish the second connection via the non-3GPP access (e.g., the NIN3A 990) even when the first connection via the 3GPP access (e.g., the 3GPPA 980) is not available. Put another way, in some aspects the token may be used by the UE 120 to establish the non-3GPP access connection even if the 3GPP access is not available for some reason. In such aspects, the multi-access session (e.g., the PDU session) may not be released for a predefined time interval even if the 3GPP access is down (e.g., the SMF 445 may configure the MPQUIC proxy 820 to accept an incoming connection for a predefined time interval).

Moreover, as shown by reference number 997, establishing the second connection between the UE 120 and the UPF 450 via the non-3GPP access may include the UPF 450 (e.g., the filter component 825 of the UPF 450) validating the UE 120 as a trusted user of the non-3GPP access based at least in part on the token and/or the connection ID, which may be performed in a substantially similar manner as described above in connection with reference number 860 of FIG. 8. For example, in aspects in which the UE 120 is validated as a trusted user based on the connection ID alone, the UPF 450 may compare the connection ID included in the connection request with a list of known trusted connection IDs to determine if the UE 120 is a trusted user of the non-3GPP access. Similarly, in aspects in which the UE 120 is validated as a trusted user based on the token alone, such as in aspects in which the token is a randomly generated token, the UPF 450 may compare the token included in the connection request with a list of known trusted tokens to determine if the UE 120 is a trusted user of the non-3GPP access (e.g., the UPF 450 may match the token in the new traffic with a token previously stored). Put another way, in aspects in which the token is randomly generated, the token in the connection request may be used as an identifier for the UPF 450 to identify the associated multi-access session (e.g., the associated PDU session), and thus the UPF 450 may compare the token in the connection request (e.g., the token transmitted by the UE 120 over the NIN3A 990) with the identified UE 120 multi-access session information to determine whether to allow the connection request over non-3GPP access.

In some other aspects, such as in aspects in which the token is used to verify the UE 120 as a trusted user of the non-3GPP access and the token is generated based on multi-access session information associated with the UE 120 (e.g., the connection ID), the UPF 450 may generate a token using information provided in the connection request and compare the generated token to the token included in the connection request to determine if the tokens match, indicating that the UE 120 is a trusted user of the non-3GPP access. For example, in aspects in which the token is generated based at least in part on a connection ID associated with the UE 120 (e.g., in aspects in which the token is generated using an HMAC that uses the connection ID, among other information, as input), the UPF 450 may take the connection ID from the connection request and compute a token using the connection ID and any other information stored at the UPF 450 (e.g., an ATSSS key and/or any other input parameters described above in connection with reference number 940). Moreover, in aspects in which the token is generated based at least in part on using an HMAC using the ATSSS key and the connection ID, and in aspects in which a multipath protocol proxy (e.g., the MPQUIC proxy 820) of the UPF 450 is associated with a plurality of ATSSS keys, the UPF 450 may receive, from the SMF 445, an indication of an ATSSS key ID associated with the token (as described above in connection with reference number 950) and/or the UPF 450 may validate the UE 120 as the trusted user of the non-3GPP access based at least in part on the ATSSS key ID.

If the token included in the connection request matches the token computed at the UPF 450 (e.g., computed using the connection ID, the ATSSS key, and/or any additional information such as the multipath protocol proxy IP address, among other examples), the UPF 450 may store information associated with the UE 120 (e.g., a source IP address (e.g., from the internet) associated with the UE 120 and/or a port number associated with the UE 120) as allowed, and thus the UPF 450 may allow future traffic from that address without requiring a token and/or connection ID to be included with the future traffic. For example, as indicated by reference number 999, the UE 120 may transmit, to the UPF 450 (e.g., the MPQUIC proxy 820 of the UPF 450) and after the second connection is established, a communication that omits the token and/or the connection ID. For example, the UE 120 may transmit the subsequent communication using a multipath protocol (e.g., a MPQUIC protocol, an MPTCP protocol, and/or a similar multipath protocol). In such aspects, because the UPF 450 may have previously verified the UE 120 as a trusted user of the non-3GPP access via the token and/or the connection ID included in the connection request, the UPF 450 may recognize the subsequent communication as an allowed communication. Put another way, in some aspects the token and/or associated connection ID may only be used for an initial connection filtering purpose (e.g., the token and/or the associated connection ID may only be applicable to the initial informing connection request (e.g., 0-RTT connection request in TLS, among other examples)), and thus subsequent packet and/or frame handling, if any, may follow an established protocol, such as an MPQUIC protocol, an MPTCP protocol, and/or a similar protocol.

In some aspects, such as in aspects in which a core network entity (e.g., the SMF 445 or the UPF 450) generates the token, certain token policies (e.g., expiration, a quantity of uses, and/or the like, described in more detail below) may be set by the core network. For example, in aspects in which the token is generated by the SMF 445, certain token policies may be set in the SMF 445, such as via an operation, administration, and maintenance (OAM) entity associated with the SMF 445, and/or such as by the SMF 445 retrieving the token policies from the UDM 425, among other examples. In aspects in which the token is generated by the UPF 450, the token policies may be set in the UPF 450 by the SMF 445 (e.g., the SMF 445 may indicate the token policies to the UPF 450, such as via the signaling described above in connection with reference number 950).

In some aspects, the token policies may include a time period during which the token is valid (sometimes referred to herein as a token validity time and/or a token lifetime). In such aspects, the token validity time may be explicit (e.g., may be known to the UE 120) and/or the token lifetime may be signaled to the UE 120 with the token (e.g., via the signaling described above in connection with reference number 970). In such aspects, the UE 120 may be informed as to how long a connection via the non-3GPP access (e.g., the NIN3A 990 and/or the Nx interface) is allowed. In some other aspects, the token validity time may be implicit (e.g., may not be known to the UE 120). For example, the token lifetime may be configured at the network and/or indicated to the UPF 450 (e.g., via the signaling described above in connection with reference number 950), but no indication of the token validity time may be provided to the UE 120. In such aspects, the UE 120 may not be informed as to how long a connection via the non-3GPP access (e.g., the NIN3A 990 and/or the Nx interface) is allowed, and thus the UE 120 may be configured to use the token shortly after receiving the token from the network (e.g., from the SMF 445). Additionally, or alternatively, in aspects in which the token validity time is implicit, if the token does not work to establish a connection via the non-3GPP access (e.g., the NIN3A 990), the UE 120 may be required to request another token and/or a renewed token, such as by transmitting a request for a token over a 3GPP access (e.g., over the 3GPPA 980).

Additionally, or alternatively, in some aspects the token may be a single-use token. Put another way, the token may be configured to be used one time (e.g., by including the token in a connection request) and, once consumed, the token may expire (e.g., which may be enforced using a connection ID or similar ID associated with the UE 120). In such aspects, if the token is derived from an ATSSS key and/or a connection ID (e.g., in aspects in which the token is generated using an HMAC associated with an ATSSS key and/or connection ID), connection IDs may not be recycled for the same ATSSS key (e.g., each UE 120 may be provided with a unique connection ID, such as for a purpose of enforcing a single use of a token). In some other aspects, such as in aspects in which a single-use token is randomly generated, once a token is consumed, the token may be marked as consumed. In such aspects, a new token may be assigned to a given connection ID when reallocated. In some other aspects, the token may be a multi-use token. Put another way, a token may be configured to be used multiple times during the token lifetime. In such aspects, a maximum number of reuses of the token may be configured by the network, such as for a purpose of reducing instances of replay attacks associated with the multi-use token.

In some aspects, if a token has expired and/or has been consumed, the UE 120 may be configured to request a renewed token. For example, the UE 120 may be configured to transmit, to the network, a request for a renewed token, and/or one or more network entities may be configured to transmit, to the UE 120, a renewed token based at least in part on the request for the renewed token. In some aspects, the token policies may limit requests for renewed tokens to be transmitted via a 3GPP access. For example, the token policies may require that the UE 120 transmit any requests for a new token to the SMF 445 using a 3GPP access (e.g., in some aspects, a renewed token may always be obtained via NAS signaling). In some other aspects, the token policies may permit requests for renewed tokens to be transmitted via a non-3GPP access (sometimes referred to herein as in-band token renewal). For example, the token policies may permit the UE 120 to transmit any requests for a new token to the UPF 450 using a non-3GPP access (e.g., the NIN3A 990). In such aspects, an address validation token may be defined in a protocol (e.g., the QUIC protocol, the MPQUIC protocol, the MPTCP protocol, and/or a similar protocol), and/or token renewal may be restricted to a same address (e.g., a same IP address) that was previously verified by the UPF 450 (e.g., the filter component 825 of the UPF 450).

In some aspects, one or more of the network entities may be capable of revoking a previously generated and/or allocated token. For example, in aspects in which the token is generated by the SMF 445 and/or the UPF 450, the issuing entity may be capable of revoking the token (e.g., the SMF 445 may be capable of revoking tokens generated and/or allocated by the SMF 445 and/or the UPF 450 may be capable of revoking tokens generated and/or allocated by the UPF 450). In aspects in which the token is generated using an ATSSS key (e.g., by using an HMAC based at least in part on the ATSSS key, the connection ID, and/or similar information), a token may be revoked by using connection ID blacklisting (e.g., by adding a connection ID associated with a revoked token to a data structure, such as a table or similar structure, such that the UPF 450 may identify the connection ID as one associated with a revoked token). Additionally, or alternatively, in aspects involving a randomly generated token, a token may be revoked by marking the token as invalid (e.g., within a data structure maintained at the UPF 450) and/or by revoking a connection ID associated with the token, among other examples.

Based at least in part on the UE 120 and the UPF 450 using a token-based connection request to establish a connection via a non-3GPP access (e.g., an NIN3A) of a multi-access session, the UE 120, the SMF 445, and/or the UPF 450 may conserve computing, power, network, and/or communication resources that may have otherwise been consumed traditional ATSSS architectures and/or traditional multi-access session establishment procedures. For example, based at least in part on the UE 120 and the UPF 450 using a token-based connection request to establish a connection via a non-3GPP access (e.g., an NIN3A) of a multi-access session, the UE 120, the SMF 445, and/or the UPF 450 may communicate using fewer entities and/or less overhead than associated with full-featured ATSSS architectures and/or may communicate with enhanced security as compared to certain ATSSS-lite architectures.

As indicated above, FIGS. 9A-9C are provided as an example. Other examples may differ from what is described with respect to FIGS. 9A-9C.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with techniques for enabling token-based connections for an ATSSS architecture.

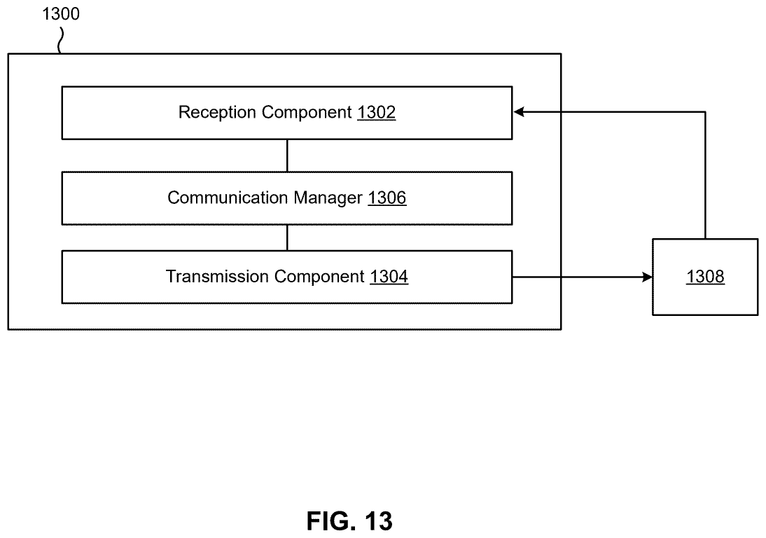

As shown in FIG. 10, in some aspects, process 1000 may include transmitting, over a 3GPP access to a network, a request to establish a PDU session for communications between the UE and a network entity, wherein the request to establish the PDU session includes an indication for establishment of connectivity with the network entity via a non-3GPP access to the network, and wherein the PDU session includes a first connection via the 3GPP access and a second connection via the non-3GPP access (block 1010). For example, the UE (e.g., using communication manager 1306 and/or transmission component 1304, depicted in FIG. 13) may transmit, over a 3GPP access to a network, a request to establish a PDU session for communications between the UE and a network entity, wherein the request to establish the PDU session includes an indication for establishment of connectivity with the network entity via a non-3GPP access to the network, and wherein the PDU session includes a first connection via the 3GPP access and a second connection via the non-3GPP access, as described above.

As further shown in FIG. 10, in some aspects, process 1000 may include receiving, from the network, a set of connection parameters for connecting to the network entity via the PDU session, wherein the set of connection parameters includes at least one of a connection identifier, a token, or an IP address of the network entity (block 1020). For example, the UE (e.g., using reception component 1302 and/or communication manager 1306, depicted in FIG. 13) may receive, from the network, a set of connection parameters for connecting to the network entity via the PDU session, wherein the set of connection parameters includes at least one of a connection identifier, a token, or an IP address of the network entity, as described above.

As further shown in FIG. 10, in some aspects, process 1000 may include establishing the first connection with the network entity via the 3GPP access (block 1030). For example, the UE (e.g., using communication manager 1306, depicted in FIG. 13) may establish the first connection with the network entity via the 3GPP access, as described above.

As further shown in FIG. 10, in some aspects, process 1000 may include establishing the second connection with the network entity via the non-3GPP access, wherein establishing the second connection includes transmitting a connection request, via the non-3GPP access, that includes at least one of the token or the connection identifier (block 1040). For example, the UE (e.g., using communication manager 1306 and/or transmission component 1304, depicted in FIG. 13) may establish the second connection with the network entity via the non-3GPP access, wherein establishing the second connection includes transmitting a connection request, via the non-3GPP access, that includes at least one of the token or the connection identifier, as described above.

Process 1000 may include additional aspects, such as any single aspect or any combination of aspects described below and/or in connection with one or more other processes described elsewhere herein.

In a first aspect, the network is a 3GPP core network, the network entity is within the 3GPP core network and supports multiple connections with the UE, and the multiple connections include at least the first connection and the second connection.

In a second aspect, alone or in combination with the first aspect, the IP address of the network entity is a public address accessible from the Internet.

In a third aspect, alone or in combination with one or more of the first and second aspects, receiving the set of connection parameters includes receiving the set of connection parameters as part of a PDU session establishment procedure.

In a fourth aspect, alone or in combination with one or more of the first through third aspects, receiving the set of connection parameters includes receiving the token, and the token is generated by a session management function entity of the network.

In a fifth aspect, alone or in combination with one or more of the first through fourth aspects, receiving the set of connection parameters includes receiving the token, and the token is generated by a user plane function entity of the network.

In a sixth aspect, alone or in combination with one or more of the first through fifth aspects, process 1000 includes generating the token, wherein transmitting the request to establish the PDU session includes transmitting the token to the network.

In a seventh aspect, alone or in combination with one or more of the first through sixth aspects, process 1000 includes transmitting, after the second connection is established, a communication that omits the at least one of the token or the connection identifier, wherein transmitting the communication that omits the at least one of the token or the connection identifier includes transmitting the communication using a multipath protocol.

In an eighth aspect, alone or in combination with one or more of the first through seventh aspects, establishing the second connection via the non-3GPP access is performed when the first connection via the 3GPP access is not available.

In a ninth aspect, alone or in combination with one or more of the first through eighth aspects, the connection request includes the token, and the token is generated using an ATSSS key.

In a tenth aspect, alone or in combination with one or more of the first through ninth aspects, the connection request further includes the connection identifier, and the token is generated based at least in part on using a hash-based message authentication code using the ATSSS key and the connection identifier.

In an eleventh aspect, alone or in combination with one or more of the first through tenth aspects, the connection identifier is a QUIC protocol connection identifier associated with the UE.

In a twelfth aspect, alone or in combination with one or more of the first through eleventh aspects, a multipath protocol proxy associated with the network entity is associated with a plurality of ATSSS keys, and each ATSSS key, of the plurality of ATSSS keys, is associated with a corresponding ATSSS key identifier.

In a thirteenth aspect, alone or in combination with one or more of the first through twelfth aspects, the connection request includes the token, and the token is a randomly generated token.

In a fourteenth aspect, alone or in combination with one or more of the first through thirteenth aspects, the connection request includes the token, and the token is associated with a time period during which the token is valid.

In a fifteenth aspect, alone or in combination with one or more of the first through fourteenth aspects, the connection request includes the token, and the token is a single-use token.

In a sixteenth aspect, alone or in combination with one or more of the first through fifteenth aspects, the connection request includes the token, and the token is a multi-use token.

In a seventeenth aspect, alone or in combination with one or more of the first through sixteenth aspects, process 1000 includes transmitting a request for a renewed token.

In an eighteenth aspect, alone or in combination with one or more of the first through seventeenth aspects, transmitting the request for the renewed token includes transmitting the request for the renewed token via the 3GPP access.

In a nineteenth aspect, alone or in combination with one or more of the first through eighteenth aspects, transmitting the request for the renewed token includes transmitting the request for the renewed token via the non-3GPP access.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at an UPF entity or an apparatus of an UPF entity, in accordance with the present disclosure. Example process 1100 is an example where the apparatus or the UPF entity (e.g., UPF 450) performs operations associated with techniques for enabling token-based connections for an ATSSS architecture.

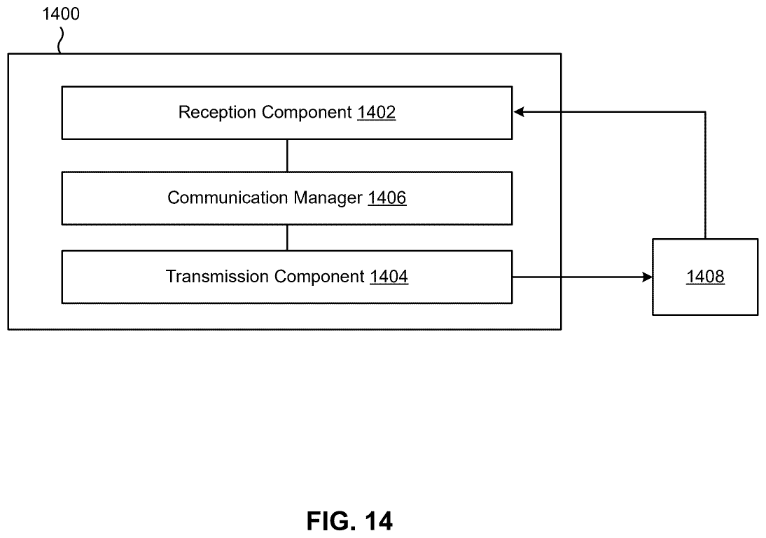

As shown in FIG. 11, in some aspects, process 1100 may include establishing, with a UE, a first connection of a PDU session for communications between the UE and the UPF entity, wherein the PDU session includes the first connection via a 3GPP access to the network and a second connection via a non-3GPP access to the network (block 1110). For example, the UPF entity (e.g., using communication manager 1406 and/or reception component 1402, depicted in FIG. 14) may establish, with a UE, a first connection of a PDU session for communications between the UE and the UPF entity, wherein the PDU session includes the first connection via a 3GPP access to the network and a second connection via a non-3GPP access to the network, as described above.

As further shown in FIG. 11, in some aspects, process 1100 may include establishing, with the UE, the second connection of the PDU session, wherein establishing the second connection includes: receiving, via the non-3GPP access, a connection request that includes at least one of a token or a connection identifier, and validating the UE as a trusted user of the non-3GPP access based at least in part on the at least one of the token or the connection identifier (block 1120). For example, the UPF entity (e.g., using communication manager 1406 and/or reception component 1402, depicted in FIG. 14) may establish, with the UE, the second connection of the PDU session, wherein establishing the second connection includes: receiving, via the non-3GPP access, a connection request that includes at least one of a token or a connection identifier, and validating the UE as a trusted user of the non-3GPP access based at least in part on the at least one of the token or the connection identifier, as described above.

Process 1100 may include additional aspects, such as any single aspect or any combination of aspects described below and/or in connection with one or more other processes described elsewhere herein.

In a first aspect, the network is a 3GPP core network, and the UPF entity is within the 3GPP core network.

In a second aspect, alone or in combination with the first aspect, the connection request includes the token, and the token is generated by a session management function entity of the network.

In a third aspect, alone or in combination with one or more of the first and second aspects, the connection request includes the token, and process 1100 includes receiving, from an SMF entity of the network, a request to generate the token, generating the token based at least in part on receiving the request to generate the token, and transmitting the token to the SMF entity.

In a fourth aspect, alone or in combination with one or more of the first through third aspects, process 1100 includes receiving, from the SMF entity, an indication of an ATSSS key associated with a multipath protocol proxy associated with the UPF entity, wherein generating the token includes generating the token based at least in part on the ATSSS key.

In a fifth aspect, alone or in combination with one or more of the first through fourth aspects, the connection request includes the token, the token is generated by the UE and transmitted to an SMF entity of the network, and process 1100 includes receiving the token from the SMF entity.

In a sixth aspect, alone or in combination with one or more of the first through fifth aspects, process 1100 includes receiving, from the UE after the second connection is established, a communication that omits the at least one of the token or the connection identifier, wherein receiving the communication that omits the at least one of the token or the connection identifier includes receiving the communication using a multipath protocol.

In a seventh aspect, alone or in combination with one or more of the first through sixth aspects, establishing the second connection via the non-3GPP access is performed when the first connection via the 3GPP access is not available.

In an eighth aspect, alone or in combination with one or more of the first through seventh aspects, the connection request includes the token, and the token is generated using an ATSSS key.

In a ninth aspect, alone or in combination with one or more of the first through eighth aspects, the connection request further includes the connection identifier, and the token is generated based at least in part on using a hash-based message authentication code using the ATSSS key and the connection identifier.

In a tenth aspect, alone or in combination with one or more of the first through ninth aspects, the connection identifier is a QUIC protocol connection identifier associated with the UE.

In an eleventh aspect, alone or in combination with one or more of the first through tenth aspects, a multipath protocol proxy associated with UPF entity is associated with a plurality of ATSSS keys, each ATSSS key, of the plurality of ATSSS keys, is associated with a corresponding ATSSS key identifier, and process 1100 includes receiving, from a session management function entity associated with the network, an indication of an ATSSS key identifier associated with the token, wherein validating the UE as the trusted user of the non-3GPP access further includes validating the UE as the trusted user of the non-3GPP access based at least in part on the ATSSS key identifier.

In a twelfth aspect, alone or in combination with one or more of the first through eleventh aspects, the connection request includes the token, and the token is a randomly generated token.

In a thirteenth aspect, alone or in combination with one or more of the first through twelfth aspects, the connection request includes the token, and the token is associated with a time period during which the token is valid.

In a fourteenth aspect, alone or in combination with one or more of the first through thirteenth aspects, the connection request includes the token, and the token is a single-use token.

In a fifteenth aspect, alone or in combination with one or more of the first through fourteenth aspects, the connection request includes the token, and the token is a multi-use token.

In a sixteenth aspect, alone or in combination with one or more of the first through fifteenth aspects, process 1100 includes receiving a request for a renewed token.

In a seventeenth aspect, alone or in combination with one or more of the first through sixteenth aspects, the request for the renewed token is received via the non-3GPP access.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at an SMF entity or an apparatus of an SMF entity, in accordance with the present disclosure. Example process 1200 is an example where the apparatus or the SMF entity (e.g., SMF 445) performs operations associated with techniques for enabling token-based connections for an ATSSS architecture.

As shown in FIG. 12, in some aspects, process 1200 may include receiving, from a UE over a 3GPP access to the network, a request to establish a PDU session for communications between the UE and a network entity, wherein the request to establish the PDU session includes an indication for establishment of connectivity with the network entity via a non-3GPP access to the network, and wherein the PDU session includes a first connection via a the 3GPP access and a second connection via the non-3GPP access (block 1210). For example, the SMF entity (e.g., using reception component 1402 and/or communication manager 1406, depicted in FIG. 14) may receive, from a UE over a 3GPP access to the network, a request to establish a PDU session for communications between the UE and a network entity, wherein the request to establish the PDU session includes an indication for establishment of connectivity with the network entity via a non-3GPP access to the network, and wherein the PDU session includes a first connection via a the 3GPP access and a second connection via the non-3GPP access, as described above.

As further shown in FIG. 12, in some aspects, process 1200 may include transmitting, to the UE, a set of connection parameters for connecting to the network entity via the PDU session, wherein the set of connection parameters includes an IP address of the network entity, and wherein at least one of: the request to establish the PDU session includes a token that is used to establish the second connection via the non-3GPP access, or the set of connection parameters includes at least one of the token or a connection identifier that is used to establish the second connection via the non-3GPP access (block 1220). For example, the SMF entity (e.g., using transmission component 1404 and/or communication manager 1406, depicted in FIG. 14) may transmit, to the UE, a set of connection parameters for connecting to the network entity via the PDU session, wherein the set of connection parameters includes an IP address of the network entity, and wherein at least one of: the request to establish the PDU session includes a token that is used to establish the second connection via the non-3GPP access, or the set of connection parameters includes at least one of the token or a connection identifier that is used to establish the second connection via the non-3GPP access, as described above.

Process 1200 may include additional aspects, such as any single aspect or any combination of aspects described below and/or in connection with one or more other processes described elsewhere herein.

In a first aspect, the network is a 3GPP core network, and the SMF entity is within the 3GPP core network.

In a second aspect, alone or in combination with the first aspect, the IP address of the network entity is a public address accessible from the Internet.

In a third aspect, alone or in combination with one or more of the first and second aspects, transmitting the set of connection parameters includes transmitting the set of connection parameters as part of a PDU session establishment procedure.

In a fourth aspect, alone or in combination with one or more of the first through third aspects, transmitting the set of connection parameters includes transmitting the token, and process 1200 includes generating the token.

In a fifth aspect, alone or in combination with one or more of the first through fourth aspects, transmitting the set of connection parameters includes transmitting the token, and process 1200 includes transmitting, to a UPF entity of the network, a request to generate the token, and receiving, from the UPF entity, the token based at least in part on the request to generate the token.

In a sixth aspect, alone or in combination with one or more of the first through fifth aspects, process 1200 includes transmitting, to the UPF entity, an indication of an ATSSS key associated with a multipath protocol proxy associated with the UPF entity, wherein the token is generated at the UPF entity based at least in part on the ATSSS key.

In a seventh aspect, alone or in combination with one or more of the first through sixth aspects, the request to establish the PDU session includes the token, and process 1200 includes transmitting the token to a user plane function entity of the network.

In an eighth aspect, alone or in combination with one or more of the first through seventh aspects, the set of connection parameters includes the token, and the token is generated using an ATSSS key.

In a ninth aspect, alone or in combination with one or more of the first through eighth aspects, the set of connection parameters further includes the connection identifier, and the token is generated based at least in part on using a hash-based message authentication code using the ATSSS key and the connection identifier.

In a tenth aspect, alone or in combination with one or more of the first through ninth aspects, the connection identifier is a QUIC protocol connection identifier associated with the UE.

In an eleventh aspect, alone or in combination with one or more of the first through tenth aspects, a multipath protocol proxy associated with the network entity is associated with a plurality of ATSSS keys, each ATSSS key, of the plurality of ATSSS keys, is associated with a corresponding ATSSS key identifier, and process 1200 includes transmitting, to a user plane function entity associated with the network, an indication of an ATSSS key identifier associated with the token.

In a twelfth aspect, alone or in combination with one or more of the first through eleventh aspects, the set of connection parameters includes the token, and the token is a randomly generated token.

In a thirteenth aspect, alone or in combination with one or more of the first through twelfth aspects, the set of connection parameters includes the token, and the token is associated with a time period during which the token is valid.

In a fourteenth aspect, alone or in combination with one or more of the first through thirteenth aspects, the set of connection parameters includes the token, and the token is a single-use token.

In a fifteenth aspect, alone or in combination with one or more of the first through fourteenth aspects, the set of connection parameters includes the token, and the token is a multi-use token.

In a sixteenth aspect, alone or in combination with one or more of the first through fifteenth aspects, process 1200 includes receiving, from the UE, a request for a renewed token, and transmitting, to the UE, a renewed token based at least in part on the request for the renewed token.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 8 and 9A-9C. Additionally, or alternatively, the apparatus 1300 may be configured to perform one or more processes described herein, such as process 1000 of FIG. 10. In some aspects, the apparatus 1300 and/or one or more components shown in FIG. 13 may include one or more components of the UE 120 described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE 120 described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE 120 described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The communication manager 1306 and/or the transmission component 1304 may transmit, over a 3GPP access to a network, a request to establish a PDU session for communications between the UE and a network entity, wherein the request to establish the PDU session includes an indication for establishment of connectivity with the network entity via a non-3GPP access to the network, and wherein the PDU session includes a first connection via the 3GPP access and a second connection via the non-3GPP access. The reception component 1302 may receive, from the network, a set of connection parameters for connecting to the network entity via the PDU session, wherein the set of connection parameters includes at least one of a connection identifier, a token, or an IP address of the network entity. The communication manager 1306 and/or the transmission component 1304 may establish the first connection with the network entity via the 3GPP access. The communication manager 1306 and/or the transmission component 1304 may establish the second connection with the network entity via the non-3GPP access, wherein establishing the second connection includes transmitting a connection request, via the non-3GPP access, that includes at least one of the token or the connection identifier.

The communication manager 1306 may generate the token, wherein transmitting the request to establish the PDU session includes transmitting the token to the network.

The transmission component 1304 may transmit, after the second connection is established, a communication that omits the at least one of the token or the connection identifier, wherein transmitting the communication that omits the at least one of the token or the connection identifier includes transmitting the communication using a multipath protocol.

The transmission component 1304 may transmit a request for a renewed token.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus may be associated with an SMF entity (e.g., SMF 445) and/or a UPF entity (e.g., UPF 450). In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIG. 8 and FIGS. 9A-9C. Additionally, or alternatively, the apparatus 1400 may be configured to perform one or more processes described herein, such as process 1100 of FIG. 11, process 1200 of FIG. 12, or a combination thereof. In some aspects, the apparatus 1400 and/or one or more components shown in FIG. 14 may include one or more components of the network node 110 described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network node 110 described in connection with FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the network node 110 described in connection with FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The communication manager 1406 and/or the reception component 1402 may establish, with a UE, a first connection of a PDU session for communications between the UE and the UPF entity, wherein the PDU session includes the first connection via a 3GPP access to the network and a second connection via a non-3GPP access to the network. The communication manager 1406 and/or the reception component 1402 may establish, with the UE, the second connection of the PDU session, wherein establishing the second connection includes: receiving, via the non-3GPP access, a connection request that includes at least one of a token or a connection identifier, and validating the UE as a trusted user of the non-3GPP access based at least in part on the at least one of the token or the connection identifier.

The communication manager 1406 and/or the reception component 1402 may receive, from an SMF entity of the network, a request to generate the token. The communication manager 1406 may generate the token based at least in part on receiving the request to generate the token. The transmission component 1404 may transmit the token to the SMF entity.

The reception component 1402 may receive, from the SMF entity, an indication of an ATSSS key associated with a multipath protocol proxy associated with the UPF entity, wherein generating the token includes generating the token based at least in part on the ATSSS key.

The reception component 1402 may receive the token from the SMF entity.

The reception component 1402 may receive, from the UE after the second connection is established, a communication that omits the at least one of the token or the connection identifier, wherein receiving the communication that omits the at least one of the token or the connection identifier includes receiving the communication using a multipath protocol.

The reception component 1402 may receive, from a session management function entity associated with the network, an indication of an ATSSS key identifier associated with the token, wherein validating the UE as the trusted user of the non-3GPP access further includes validating the UE as the trusted user of the non-3GPP access based at least in part on the ATSSS key identifier.

The reception component 1402 may receive a request for a renewed token.

The reception component 1402 may receive, from a UE over a 3GPP access to the network, a request to establish a PDU session for communications between the UE and a network entity, wherein the request to establish the PDU session includes an indication for establishment of connectivity with the network entity via a non-3GPP access to the network, and wherein the PDU session includes a first connection via a the 3GPP access and a second connection via the non-3GPP access. The transmission component 1404 may transmit, to the UE, a set of connection parameters for connecting to the network entity via the PDU session, wherein the set of connection parameters includes an IP address of the network entity, and wherein at least one of: the request to establish the PDU session includes a token that is used to establish the second connection via the non-3GPP access, or the set of connection parameters includes at least one of the token or a connection identifier that is used to establish the second connection via the non-3GPP access.

The transmission component 1404 may transmit, to a UPF entity of the network, a request to generate the token. The reception component 1402 may receive, from the UPF entity, the token based at least in part on the request to generate the token.

The transmission component 1404 may transmit, to the UPF entity, an indication of an ATSSS key associated with a multipath protocol proxy associated with the UPF entity, wherein the token is generated at the UPF entity based at least in part on the ATSSS key.

The transmission component 1404 may transmit the token to a user plane function entity of the network.

The transmission component 1404 may transmit, to a user plane function entity associated with the network, an indication of an ATSSS key identifier associated with the token.

The reception component 1402 and/or the transmission component 1404 may receive, from the UE, a request for a renewed token, and transmit, to the UE, a renewed token based at least in part on the request for the renewed token.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: transmitting, over a Third Generation Partnership Project (3GPP) access to a network, a request to establish a protocol data unit (PDU) session for communications between the UE and a network entity, wherein the request to establish the PDU session includes an indication for establishment of connectivity with the network entity via a non-3GPP access to the network, and wherein the PDU session includes a first connection via the 3GPP access and a second connection via the non-3GPP access; receiving, from the network, a set of connection parameters for connecting to the network entity via the PDU session, wherein the set of connection parameters includes at least one of a connection identifier, a token, or an internet protocol (IP) address of the network entity; establishing the first connection with the network entity via the 3GPP access; and establishing the second connection with the network entity via the non-3GPP access, wherein establishing the second connection includes transmitting a connection request, via the non-3GPP access, that includes at least one of the token or the connection identifier.

Aspect 2: The method of Aspect 1, wherein the network is a 3GPP core network, wherein the network entity is within the 3GPP core network and supports multiple connections with the UE, and wherein the multiple connections include at least the first connection and the second connection.

Aspect 3: The method of any of Aspects 1-2, wherein the IP address of the network entity is a public address accessible from the Internet.

Aspect 4: The method of any of Aspects 1-3, wherein receiving the set of connection parameters includes receiving the set of connection parameters as part of a PDU session establishment procedure.

Aspect 5: The method of any of Aspects 1-4, wherein receiving the set of connection parameters includes receiving the token, and wherein the token is generated by a session management function entity of the network.

Aspect 6: The method of any of Aspects 1-5, wherein receiving the set of connection parameters includes receiving the token, and wherein the token is generated by a user plane function entity of the network.

Aspect 7: The method of any of Aspects 1-6, further comprising generating the token, wherein transmitting the request to establish the PDU session includes transmitting the token to the network.

Aspect 8: The method of any of Aspects 1-7, further comprising transmitting, after the second connection is established, a communication that omits the at least one of the token or the connection identifier, wherein transmitting the communication that omits the at least one of the token or the connection identifier includes transmitting the communication using a multipath protocol.

Aspect 9: The method of any of Aspects 1-8, wherein establishing the second connection via the non-3GPP access is performed when the first connection via the 3GPP access is not available.

Aspect 10: The method of any of Aspects 1-9, wherein the connection request includes the token, and wherein the token is generated using an access traffic steering, switching, and splitting key (ATSSS) key.

Aspect 11: The method of Aspect 10, wherein the connection request further includes the connection identifier, and wherein the token is generated based at least in part on using a hash-based message authentication code using the ATSSS key and the connection identifier.

Aspect 12: The method of Aspect 11, wherein the connection identifier is a QUIC protocol connection identifier associated with the UE.

Aspect 13: The method of Aspect 10, wherein a multipath protocol proxy associated with the network entity is associated with a plurality of ATSSS keys, and wherein each ATSSS key, of the plurality of ATSSS keys, is associated with a corresponding ATSSS key identifier.

Aspect 14: The method of any of Aspects 1-13, wherein the connection request includes the token, and wherein the token is a randomly generated token.

Aspect 15: The method of any of Aspects 1-14, wherein the connection request includes the token, and wherein the token is associated with a time period during which the token is valid.

Aspect 16: The method of any of Aspects 1-15, wherein the connection request includes the token, and wherein the token is a single-use token.

Aspect 17: The method of any of Aspects 1-16, wherein the connection request includes the token, and wherein the token is a multi-use token.

Aspect 18: The method of any of Aspects 1-17, further comprising transmitting a request for a renewed token.

Aspect 19: The method of Aspect 18, wherein transmitting the request for the renewed token includes transmitting the request for the renewed token via the 3GPP access.

Aspect 20: The method of Aspect 18, wherein transmitting the request for the renewed token includes transmitting the request for the renewed token via the non-3GPP access.

Aspect 21: A method of wireless communication performed by a user plane function (UPF) entity of a network, comprising: establishing, with a user equipment (UE), a first connection of a protocol data unit (PDU) session for communications between the UE and the UPF entity, wherein the PDU session includes the first connection via a Third Generation Partnership Project (3GPP) access to the network and a second connection via a non-3GPP access to the network; and establishing, with the UE, the second connection of the PDU session, wherein establishing the second connection includes: receiving, via the non-3GPP access, a connection request that includes at least one of a token or a connection identifier, and validating the UE as a trusted user of the non-3GPP access based at least in part on the at least one of the token or the connection identifier.

Aspect 22: The method of Aspect 21, wherein the network is a 3GPP core network, and wherein the UPF entity is within the 3GPP core network.

Aspect 23: The method of any of Aspects 21-22, wherein the connection request includes the token, and wherein the token is generated by a session management function entity of the network.

Aspect 24: The method of any of Aspects 21-23, wherein the connection request includes the token, and wherein the method further comprises: receiving, from a session management function (SMF) entity of the network, a request to generate the token; generating the token based at least in part on receiving the request to generate the token; and transmitting the token to the SMF entity.

Aspect 25: The method of Aspect 24, further comprising receiving, from the SMF entity, an indication of an access traffic steering, switching, and splitting (ATSSS) key associated with a multipath protocol proxy associated with the UPF entity, wherein generating the token includes generating the token based at least in part on the ATSSS key.

Aspect 26: The method of any of Aspects 21-25, wherein the connection request includes the token, wherein the token is generated by the UE and transmitted to a session management function (SMF) entity of the network, and wherein the method further comprises receiving the token from the SMF entity.

Aspect 27: The method of any of Aspects 21-26, further comprising receiving, from the UE after the second connection is established, a communication that omits the at least one of the token or the connection identifier, wherein receiving the communication that omits the at least one of the token or the connection identifier includes receiving the communication using a multipath protocol.

Aspect 28: The method of any of Aspects 21-27, wherein establishing the second connection via the non-3GPP access is performed when the first connection via the 3GPP access is not available.

Aspect 29: The method of any of Aspects 21-28, wherein the connection request includes the token, and wherein the token is generated using an access traffic steering, switching, and splitting key (ATSSS) key.

Aspect 30: The method of Aspect 29, wherein the connection request further includes the connection identifier, and wherein the token is generated based at least in part on using a hash-based message authentication code using the ATSSS key and the connection identifier.

Aspect 31: The method of Aspect 30, wherein the connection identifier is a QUIC protocol connection identifier associated with the UE.

Aspect 32: The method of Aspect 29, wherein a multipath protocol proxy associated with UPF entity is associated with a plurality of ATSSS keys, wherein each ATSSS key, of the plurality of ATSSS keys, is associated with a corresponding ATSSS key identifier, wherein the method further comprises receiving, from a session management function entity associated with the network, an indication of an ATSSS key identifier associated with the token, and wherein validating the UE as the trusted user of the non-3GPP access further includes validating the UE as the trusted user of the non-3GPP access based at least in part on the ATSSS key identifier.

Aspect 33: The method of any of Aspects 21-32, wherein the connection request includes the token, and wherein the token is a randomly generated token.

Aspect 34: The method of any of Aspects 21-33, wherein the connection request includes the token, and wherein the token is associated with a time period during which the token is valid.

Aspect 35: The method of any of Aspects 21-34, wherein the connection request includes the token, and wherein the token is a single-use token.

Aspect 36: The method of any of Aspects 21-35, wherein the connection request includes the token, and wherein the token is a multi-use token.

Aspect 37: The method of any of Aspects 21-36, further comprising receiving a request for a renewed token.

Aspect 38: The method of Aspect 37, wherein the request for the renewed token is received via the non-3GPP access.

Aspect 39: A method of wireless communication performed by a session management function (SMF) entity of a network, comprising: receiving, from a user equipment (UE) over a Third Generation Partnership Project (3GPP) access to the network, a request to establish a protocol data unit (PDU) session for communications between the UE and a network entity, wherein the request to establish the PDU session includes an indication for establishment of connectivity with the network entity via a non-3GPP access to the network, and wherein the PDU session includes a first connection via a the 3GPP access and a second connection via the non-3GPP access; and transmitting, to the UE, a set of connection parameters for connecting to the network entity via the PDU session, wherein the set of connection parameters includes an internet protocol (IP) address of the network entity, and wherein at least one of: the request to establish the PDU session includes a token that is used to establish the second connection via the non-3GPP access, or the set of connection parameters includes at least one of the token or a connection identifier that is used to establish the second connection via the non-3GPP access.

Aspect 40: The method of Aspect 39, wherein the network is a 3GPP core network, and wherein the SMF entity is within the 3GPP core network.

Aspect 41: The method of any of Aspects 39-40, wherein the IP address of the network entity is a public address accessible from the Internet.

Aspect 42: The method of any of Aspects 39-41, wherein transmitting the set of connection parameters includes transmitting the set of connection parameters as part of a PDU session establishment procedure.

Aspect 43: The method of any of Aspects 39-42, wherein transmitting the set of connection parameters includes transmitting the token, and wherein the method further comprises generating the token.

Aspect 44: The method of any of Aspects 39-43, wherein transmitting the set of connection parameters includes transmitting the token, and wherein the method further comprises: transmitting, to a user plane function (UPF) entity of the network, a request to generate the token; and receiving, from the UPF entity, the token based at least in part on the request to generate the token.

Aspect 45: The method of Aspect 44, further comprising transmitting, to the UPF entity, an indication of an access traffic steering, switching, and splitting (ATSSS) key associated with a multipath protocol proxy associated with the UPF entity, wherein the token is generated at the UPF entity based at least in part on the ATSSS key.

Aspect 46: The method of any of Aspects 39-45, wherein the request to establish the PDU session includes the token, and wherein the method further comprises transmitting the token to a user plane function entity of the network.

Aspect 47: The method of any of Aspects 39-46, wherein the set of connection parameters includes the token, and wherein the token is generated using an access traffic steering, switching, and splitting key (ATSSS) key.

Aspect 48: The method of Aspect 47, wherein the set of connection parameters further includes the connection identifier, and wherein the token is generated based at least in part on using a hash-based message authentication code using the ATSSS key and the connection identifier.

Aspect 49: The method of Aspect 48, wherein the connection identifier is a QUIC protocol connection identifier associated with the UE.

Aspect 50: The method of Aspect 47, wherein a multipath protocol proxy associated with the network entity is associated with a plurality of ATSSS keys, wherein each ATSSS key, of the plurality of ATSSS keys, is associated with a corresponding ATSSS key identifier, and wherein the method further comprises transmitting, to a user plane function entity associated with the network, an indication of an ATSSS key identifier associated with the token.

Aspect 51: The method of any of Aspects 39-50, wherein the set of connection parameters includes the token, and wherein the token is a randomly generated token.

Aspect 52: The method of any of Aspects 39-51, wherein the set of connection parameters includes the token, and wherein the token is associated with a time period during which the token is valid.

Aspect 53: The method of any of Aspects 39-52, wherein the set of connection parameters includes the token, and wherein the token is a single-use token.

Aspect 54: The method of any of Aspects 39-53, wherein the set of connection parameters includes the token, and wherein the token is a multi-use token.

Aspect 55: The method of any of Aspects 39-54, further comprising: receiving, from the UE, a request for a renewed token; and transmitting, to the UE, a renewed token based at least in part on the request for the renewed token.

Aspect 56: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-55.

Aspect 57: An apparatus for wireless communication at a device, the apparatus comprising one or more memories and one or more processors coupled to the one or more memories, the one or more processors configured to cause the device to perform the method of one or more of Aspects 1-55.

Aspect 58: An apparatus for wireless communication, the apparatus comprising at least one means for performing the method of one or more of Aspects 1-55.

Aspect 59: A non-transitory computer-readable medium storing code for wireless communication, the code comprising instructions executable by one or more processors to perform the method of one or more of Aspects 1-55.

Aspect 60: A non-transitory computer-readable medium storing a set of instructions for wireless communication, the set of instructions comprising one or more instructions that, when executed by one or more processors of a device, cause the device to perform the method of one or more of Aspects 1-55.

Aspect 61: A device for wireless communication, the device comprising a processing system that includes one or more processors and one or more memories coupled with the one or more processors, the processing system configured to cause the device to perform the method of one or more of Aspects 1-55.

Aspect 62: An apparatus for wireless communication at a device, the apparatus comprising one or more memories and one or more processors coupled to the one or more memories, the one or more processors individually or collectively configured to cause the device to perform the method of one or more of Aspects 1-55.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A user equipment (UE) for wireless communication, comprising:
one or more memories; and
one or more processors, coupled to the one or more memories, individually or collectively configured to cause the UE to:
transmit, over a Third Generation Partnership Project (3GPP) access to a network, a request to establish a protocol data unit (PDU) session for communications between the UE and a network entity,
wherein the request to establish the PDU session includes an indication for establishment of connectivity with the network entity via a non-3GPP access to the network, and
wherein the PDU session includes a first connection via the 3GPP access and a second connection via the non-3GPP access;
receive, from the network, a set of connection parameters for connecting to the network entity via the PDU session,
wherein the set of connection parameters includes at least one of a connection identifier, a token, or an internet protocol (IP) address of the network entity;
establish the first connection with the network entity via the 3GPP access; and
establish the second connection with the network entity via the non-3GPP access by transmitting a connection request, via the non-3GPP access, that includes at least one of the token or the connection identifier.

2. The UE of claim 1, wherein the network is a 3GPP core network,
wherein the network entity is within the 3GPP core network and supports multiple connections with the UE, and
wherein the multiple connections include at least the first connection and the second connection.

3. The UE of claim 1, wherein the IP address of the network entity is a public address accessible from the Internet.

4. The UE of claim 1, wherein the one or more processors, to cause the UE to receive the set of connection parameters, are individually or collectively configured to cause the UE to receive the token, and
wherein the token is generated by a session management function entity of the network.

5. The UE of claim 1, wherein the one or more processors, to cause the UE to receive the set of connection parameters, are individually or collectively configured to cause the UE to receive the token, and
wherein the token is generated by a user plane function entity of the network.

6. The UE of claim 1, wherein the one or more processors are further individually or collectively configured to cause the UE to generate the token,
wherein the one or more processors, to cause the UE to transmit the request to establish the PDU session, are individually or collectively configured to cause the UE to transmit the token to the network.

7. The UE of claim 1, wherein the connection request includes the token and the connection identifier,
wherein the token is generated based at least in part on using a hash-based message authentication code using an access traffic steering, switching, and splitting (ATSSS) key and the connection identifier,
wherein a multipath protocol proxy associated with the network entity is associated with a plurality of ATSSS keys, and
wherein each ATSSS key, of the plurality of ATSSS keys, is associated with a corresponding ATSSS key identifier.

8. The UE of claim 1, wherein the connection request includes the token, and
wherein the token is a randomly generated token.

9. The UE of claim 1, wherein the connection request includes the token, and
wherein the token is associated with a time period during which the token is valid.

10. The UE of claim 1, wherein the connection request includes the token, and
wherein the token is one of a single-use token or a multi-use token.

11. The UE of claim 1, wherein the one or more processors are further configured to cause the UE to transmit a request for a renewed token via one of the 3GPP access or the non-3GPP access.

12. A user plane function (UPF) entity for wireless communication, comprising:
one or more memories; and
one or more processors, coupled to the one or more memories, individually or collectively configured to cause the UPF entity to:
establish, with a user equipment (UE), a first connection of a protocol data unit (PDU) session for communications between the UE and the UPF entity,
wherein the PDU session includes the first connection via a Third Generation Partnership Project (3GPP) access to a network and a second connection via a non-3GPP access to the network; and
establish, with the UE, the second connection of the PDU session,
wherein the one or more processors, to cause the UPF entity to establish the second connection, are individually or collectively configured to cause the UPF entity to:
receive, via the non-3GPP access, a connection request that includes at least one of a token or a connection identifier, and
validate the UE as a trusted user of the non-3GPP access based at least in part on the at least one of the token or the connection identifier.

13. The UPF entity of claim 12, wherein the network is a 3GPP core network, and
wherein the UPF entity is within the 3GPP core network.

14. The UPF entity of claim 12, wherein the connection request includes the token, and
wherein the token is generated by a session management function entity of the network.

15. The UPF entity of claim 12, wherein the connection request includes the token, and
wherein the one or more processors are further individually or collectively configured to cause the UPF entity to:
receive, from a session management function (SMF) entity of the network, a request to generate the token;
generate the token based at least in part on receiving the request to generate the token; and
transmit the token to the SMF entity.

16. The UPF entity of claim 15, wherein the one or more processors are further individually or collectively configured to cause the UPF entity to receive, from the SMF entity, an indication of an access traffic steering, switching, and splitting (ATSSS) key associated with a multipath protocol proxy associated with the UPF entity,
wherein the one or more processors, to cause the UPF entity to generate the token, are individually or collectively configured to cause the UPF entity to generate the token based at least in part on the ATSSS key.

17. The UPF entity of claim 12, wherein the connection request includes the token,
wherein the token is generated by the UE and transmitted to a session management function (SMF) entity of the network, and
wherein the one or more processors are further individually or collectively configured to cause the UPF entity to receive the token from the SMF entity.

18. The UPF entity of claim 12, wherein the connection request includes the token and the connection identifier, and
wherein the token is generated based at least in part on using a hash-based message authentication code using an access traffic steering, switching, and splitting (ATSSS) key and the connection identifier,
wherein a multipath protocol proxy associated with the UPF entity is associated with a plurality of ATSSS keys, and
wherein each ATSSS key, of the plurality of ATSSS keys, is associated with a corresponding ATSSS key identifier.

19. The UPF entity of claim 18, wherein the one or more processors are further individually or collectively configured to cause the UPF entity to receive, from a session management function entity associated with the network, an indication of an ATSSS key identifier associated with the token, and
wherein the one or more processors, to cause the UPF entity to validate the UE as the trusted user of the non-3GPP access, are individually or collectively configured to cause the UPF entity to validate the UE as the trusted user of the non-3GPP access based at least in part on the ATSSS key identifier.

20. The UPF entity of claim 12, wherein the connection request includes the token, and
wherein the token is a randomly generated token.

21. The UPF entity of claim 12, wherein the connection request includes the token, and
wherein the token is associated with a time period during which the token is valid.

22. The UPF entity of claim 12, wherein the connection request includes the token, and
wherein the token is one of a single-use token or a multi-use token.

23. The UPF entity of claim 12, wherein the one or more processors are further individually or collectively configured to cause the UPF entity to receive a request for a renewed token via the non-3GPP access.

24. A session management function (SMF) entity for wireless communication, comprising:
one or more memories; and
one or more processors, coupled to the one or more memories, individually or collectively configured to cause the SMF entity to:
receive, from a user equipment (UE) over a Third Generation Partnership Project (3GPP) access to a network, a request to establish a protocol data unit (PDU) session for communications between the UE and a network entity,
wherein the request to establish the PDU session includes an indication for establishment of connectivity with the network entity via a non-3GPP access to the network, and
wherein the PDU session includes a first connection via the 3GPP access and a second connection via the non-3GPP access; and
transmit, to the UE, a set of connection parameters for connecting to the network entity via the PDU session,
wherein the set of connection parameters includes an internet protocol (IP) address of the network entity, and
wherein at least one of:
the request to establish the PDU session includes a token that is used to establish the second connection via the non-3GPP access, or
the set of connection parameters includes at least one of the token or a connection identifier that is used to establish the second connection via the non-3GPP access.

25. The SMF entity of claim 24, wherein the one or more processors, to cause the SMF entity to transmit the set of connection parameters, are individually or collectively configured to cause the SMF entity to transmit the token, and
wherein the one or more processors are further individually or collectively configured to cause the SMF entity to generate the token.

26. The SMF entity of claim 24, wherein the one or more processors, to cause the SMF entity to transmit the set of connection parameters, are individually or collectively configured to cause the SMF entity to transmit the token, and
wherein the one or more processors are further individually or collectively configured to cause the SMF entity to:
transmit, to a user plane function (UPF) entity of the network, a request to generate the token; and
receive, from the UPF entity, the token based at least in part on the request to generate the token.

27. A method of wireless communication performed by a user equipment (UE), comprising:
transmitting, over a Third Generation Partnership Project (3GPP) access to a network, a request to establish a protocol data unit (PDU) session for communications between the UE and a network entity,
wherein the request to establish the PDU session includes an indication for establishment of connectivity with the network entity via a non-3GPP access to the network, and
wherein the PDU session includes a first connection via the 3GPP access and a second connection via the non-3GPP access;
receiving, from the network, a set of connection parameters for connecting to the network entity via the PDU session,
wherein the set of connection parameters includes at least one of a connection identifier, a token, or an internet protocol (IP) address of the network entity;
establishing the first connection with the network entity via the 3GPP access; and
establishing the second connection with the network entity via the non-3GPP access,
wherein establishing the second connection includes transmitting a connection request, via the non-3GPP access, that includes at least one of the token or the connection identifier.

28. The method of claim 27, wherein the network is a 3GPP core network,
wherein the network entity is within the 3GPP core network and supports multiple connections with the UE, and
wherein the multiple connections include at least the first connection and the second connection.

29. The method of claim 27, wherein receiving the set of connection parameters includes receiving the token, and
wherein the token is generated by a session management function entity of the network.

30. The method of claim 27, wherein receiving the set of connection parameters includes receiving the token, and
wherein the token is generated by a user plane function entity of the network.
